(19) United States
(12) Patent Application Publication
(10) Pub. No.: US 2009/0327039 A1
(43) Pub. Date: Dec. 31, 2009

(54) Network based procurement and sourcing method

(76) Inventors: Andrew W. Cox, Warwickshire (GB); Jeremy S. Smith, London (GB); Gavin I. Bowen-Ashwin, London (GB)

Correspondence Address: DUNLAP CODDING, P.C., PO BOX 16370, OKLAHOMA CITY, OK, 73113, US

(21) Appl. No.: 12/215,076

(22) Filed: Jun. 25, 2008

(51) Int. Cl. G06Q 10/00

(52) U.S. Cl. 705/10

(57) ABSTRACT

A method for enhancing the procurement processes and sourcing strategy options of an organization, including registering purchase item data, supply item data, demand market data, and supply market data, and generating one or more suggested procurement and sourcing strategies using a power and leverage positioning methodology. The method provides a recommended level of analysis with respect to the criticality of the purchase items to generate suggested procurement and sourcing strategies. A method for developing the competence of the staff of an organization in the management of a procurement process, having a plurality of steps for the selection of procurement and sourcing strategies pre-contractually and for managing supplier performance post-contractually is also disclosed.

### CROSS-REFERENCE TO RELATED APPLICATIONS

Not Applicable.

### STATEMENT REGARDING FEDERALLY SPONSORED RESEARCH OR DEVELOPMENT.

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable.

### BACKGROUND OF THE INVENTION

A. Technical Field

This invention relates generally to the field of procurement and sourcing, and more specifically to a network based method, process and tool for enhancing the procurement processes and sourcing strategy options of an organization.

B. Background

Supply chain management is an essential part of any business. It is reported that businesses spend 60% or more of revenue on external purchases of goods and services. It is also reported that the 250 largest publicly held companies in the U.S. spent about $1.4 trillion in goods and services in 1999.

Sourcing and procurement are critical to supply chain management processes. Sourcing generally deals with the search for, identification, and management of suppliers of materials and services. Sourcing often involves locating potential suppliers and then evaluating, developing and managing their capabilities in a manner consistent with the enterprise's plans for meeting customer expectations and needs. Sourcing refers to the combined process by which organizations, first, procure suppliers by negotiating and agreeing terms and conditions pre-contractually; and, then, post-contractually, manage the physical supply of goods and/or services in relation to contractually agreed terms and conditions.

Despite its significance, conventional practices of corporate sourcing and procurement are not always as effective as they should be, and they depend heavily on human skills in finding, evaluation, engaging and retaining suppliers.

Recent developments in Internet technology promised the integration of pre and post-contractual sourcing practices into electronic process to reduce the time, effort and costs associated with purchases of goods and services.

However, currently available on-line e-procurement and e-strategic sourcing tools in the market tend to have a common intellectual foundation that can be traced back to a single way of thinking about competence. This approach focuses primarily on the benefits for buying organizations that can arise from the aggregation (or consolidation) of spend volumes with a reduced number of suppliers.

Volume leverage approaches have tended to dominate e-sourcing and e-procurement software offerings, although more recently there have been attempts to develop software-based lot optimisation approaches as well. These approaches do not necessarily encourage volume leverage only, rather they allow suppliers to offer value for money based on their specification of which elements of the buyer's volumes they would ideally prefer to provide. This may be all of the volume or only some parts of it.

E-procurement and e-sourcing tools use these volume leverage and lot optimisation approaches but currently available on-line e-procurement and e-strategic sourcing tools do not provide a methodology for understanding the full range of sourcing options available to organizations when they source goods and/or services; nor do they investigate how these sourcing options can be influenced by changes in the current and future power and leverage situation available to buyers and suppliers in markets and supply chains when they interact.

Thus, the present invention creates a procurement and sourcing tool that addresses such limitations in currently available tools by providing a power and leverage methodology integrated throughout the procurement and sourcing tool to demonstrate the full range of sourcing options available for buying organizations. This procurement and sourcing tool provides users with a better understanding of the levers available to buyers and sellers in managing the business relationships between them in constantly changing markets, and the moves that buyers and sellers can use to augment their power and leverage in the future based on a record of their current and past positions.

### SUMMARY OF THE INVENTION

In one embodiment, the present invention relates to a method for enhancing the procurement processes and sourcing strategy options of an organization including: establishing communication between one or more servers and one or more user devices; registering by the server purchase item data and supply item data; generating a criticality value for the one or more purchase items; generating technical competence and commercial congruence data; providing by the server at least a portion of the technical competence and commercial congruence data to the one or more user devices; registering by the server demand market data; registering by the servers supply market data for the one or more supply items and/or supplier(s); generating one or more suggested procurement and sourcing strategies with tactical contractual levers/options; and providing by the server at least one of the one or more suggested procurement and sourcing strategies to the one or more user devices.

In a version, the method further comprises the step of generating market positioning data indicative of the relative market powers of the organization and the suppliers; and providing at least a portion of the market positioning data to the one or more user devices.

In another version, the method further comprises the step of receiving option commands indicative of an organization's selection of one or more options selected from the group consisting of: procurement and sourcing strategy options, tactical contractual levers, relationship management and performance management options, one or more supply items, and suppliers for the supply items.

In yet another version, the method further comprises the step of registering supplier performance data indicative of the performance of at least one of one or more suppliers and one or more supply items relative to predefined performance expectations; receiving from the one or more user devices relationship management options indicative of organization selection of one or more actions to be performed on the supplier performance data.

In yet another version, the method further comprises the step of registering organization performance data indicative of the performance of the organization's staff in performing procurement strategy activities relative to predefined performance expectations; receiving from the one or more user devices performance management options indicative of organization selection of one or more actions to be performed on the organization performance data.

In another embodiment, the present invention relates to a method for developing the competence of the staff of an organization in the management of a procurement process having a plurality of steps and the selection of procurement and sourcing strategies, comprising the steps of establishing communication between one or more servers and one or more user devices utilized by staff of the organization; providing questions including competence prompts and guidance and training material to the user devices at each step of, and for each activity and task in, the procurement process.

In yet another embodiment, the present invention relates to a method for enhancing the procurement processes and sourcing strategies of an organization, comprising the steps of establishing communication between one or more server and one or more user devices; registering business criteria for one or more purchase items; collecting information with respect to the criticality of the purchase item to the organization; and providing a recommended level of analysis with respect to demand market and supply market information.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic representation of a procurement and sourcing tool constructed in accordance with the present invention.

FIG. 2 is a general diagram describing the work process of the procurement and sourcing tool.

FIG. 3 is an exemplary “Category Segmentation and Team Selection—Organizational segmentation” page generated by servers in accordance with an embodiment of the present invention.

FIG. 4 is an exemplary “Category Segmentation and Team Selection—Spend Categories” page generated by the servers in accordance with an embodiment of the present invention.

FIG. 5 is an exemplary “Category Segmentation and Team Selection—Criticality Questions” page generated by the servers in accordance with an embodiment of the present invention.

FIG. 6 is an exemplary “Category Segmentation and Team Selection—Criticality Recommendation” page generated by the servers in accordance with an embodiment of the present invention.

FIG. 7 is an exemplary “Baseline Value Proposition” page generated by the servers in accordance with an embodiment of the present invention.

FIGS. 8a and 8b are exemplary “Alternative Options” pages generated by the servers in accordance with an embodiment of the present invention.

FIG. 9 is an exemplary “Option Selection” page generated by the servers in accordance with an embodiment of the present invention.

FIG. 10a is an exemplary “Full Demand Analysis” page generated by the servers in accordance with an embodiment of the present invention.

FIG. 10b is an exemplary “Step 2 Summary” page generated by the servers in accordance with an embodiment of the present invention.

FIG. 11 is an exemplary “Full Market Questions” page generated by the servers in accordance with an embodiment of the present invention.

FIG. 12 is an exemplary “Full Supplier Analysis” page generated by the servers in accordance with an embodiment of the present invention.

FIG. 13 is an exemplary “Power Matrix” page generated by the servers in accordance with an embodiment of the present invention.

FIG. 14 is an exemplary “Competitive Forces” page generated by the servers in accordance with an embodiment of the present invention.

FIG. 15 is an exemplary “Supplier Positioning/Buyer Attractiveness Matrix” page generated by the servers in accordance with an embodiment of the present invention.

FIG. 16 is an exemplary “Performance Management Matrix” page generated by the servers in accordance with an embodiment of the present invention.

FIG. 17 is an exemplary “Purchasing Portfolio Analysis” page generated by the servers in accordance with an embodiment of the present invention.

FIG. 18 is an exemplary “Sourcing Portfolio Analysis” page generated by the servers in accordance with an embodiment of the present invention.

FIG. 19 is an exemplary “Strategic Options” page generated by the servers in accordance with an embodiment of the present invention.

FIG. 20 is an exemplary “Market Testing Options & Tactical Levers” page generated by the servers in accordance with an embodiment of the present invention.

FIG. 21 is an exemplary “Market Testing Options Prioritization Weightings” page generated by the servers in accordance with an embodiment of the present invention.

FIG. 22 is an exemplary “Prioritization” page generated by the servers in accordance with an embodiment of the present invention.

FIG. 23 is an exemplary “Market Testing Options Selection” page generated by the servers in accordance with an embodiment of the present invention.

FIG. 24 is an exemplary “Pre-qualify Suppliers for Market Test” page generated by the servers in accordance with an embodiment of the present invention.

FIG. 25 is an exemplary “Competence/Congruence” page generated by the servers in accordance with an embodiment of the present invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention. Presently preferred embodiments of the invention are shown in the above-identified figures and described in detail below. In describing the preferred embodiments, like or identical reference numerals are used to identify common or similar elements. The figures are not necessarily to scale and certain features and certain views of the figures may be shown exaggerated in scale or in schematic in the interest of clarity and conciseness.

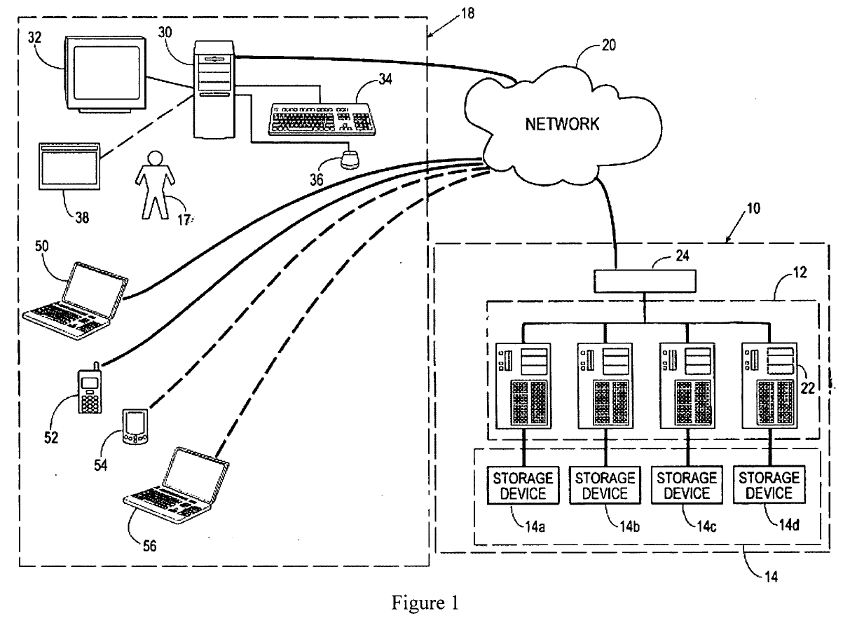

FIG. 1 illustrates a typical hardware configuration of a procurement and sourcing tool 10 suitable for implementing embodiments of the present invention.

The procurement and sourcing tool 10 communicates with one or more user devices 18 via a network 20. The network 20 can be the Internet or an Intranet or another network. The procurement and sourcing tool 10 includes an interface system 12 typically including one or more servers 22 configured to communicate with the network 20 using one or more gateways 24. When the network 20 is the Internet, the interface system 12 typically delivers a series of web pages for display at the user devices 18, and such web pages delivered by the servers 22 include various input sections and graphical user interfaces (GUIs) which enable input from the user devices 18. However, it should be understood that the interface system 12 can be replaced by another type of interface, such as a Windows-based application. This method can also be used when the user devices 18 are located in a stand-alone or non-portable environment such as a kiosk.

The network 20 may be a packetized or packet-switched network such as the world's public IP-based packet-switched networks, also known as the Internet or some other network-type, such as an Intranet, a wide area network (WAN), a local area network (LAN), or a personal area network (PAN), although the Internet is preferred because of the wide support of its underlying technologies. One embodiment of the network 20 exists in an Internet environment, which means a TCP/IP-based network. It is conceivable that in the near future, the preferred or other embodiments, may wish to use more advanced networking topologies. In addition, the network 20 does not refer only to computer-based networks but can also represent telephone communications or any other communications.

The gateway 24 is an entity or device responsible for providing access between the network 20 and the interface system 12. The gateway 24 can also be used as a security means to protect the servers 22 in the interface system 12 from attack from the network 20.

In one embodiment, the interface system 12 includes the servers 22. The configuration of the hardware for the servers 22 will depend greatly upon requirements and needs of the particular embodiment of the procurement and sourcing tool 10. Typical embodiments, including the preferred embodiment, will include multiple servers 22 with load-balancing to increase stability and availability. In one embodiment, the servers 22 reside in an intranet within an organization. In another embodiment, the servers 22 reside in the Internet, available to the public, while the access to the servers 22 from one or more user devices 18 will require authentication, invitation or verification.

It is envisioned that the servers 22 can access the storage system 14. The storage system 14 is preferably, but is not limited to, a database. The storage system 14 can include multiple storage devices. For example, four storage devices are shown in FIG. 1 and designated by reference numbers 14a, 14b, 14c, and 14d for purposes of clarity. The storage devices 14a-d can be magnetic or optical devices, memory, tape, or other types of computer readable media as well as local or remote storage controllers. The information is stored and made available for retrieval by the storage system 14.

The users 17 can access the information on the procurement and sourcing tool 10 via any of the user devices 18. The user devices 18 may be windows-based PCs, Linux-based PCs, Macintoshes, a portable device such as a laptop computer 50 (or handheld computer); a cellular telephone 52 with a micro or embedded Web browser; a portable digital assistant 54 (PDA) capable of wireless network access; a pen-based or tablet computer 56. For example, in one scenario, a user 17 uses a computer 30 with a monitor 32, a keyboard 34, and a mouse 36. Current embodiments of the procurement and sourcing tool 10 can also be modified to use any of these or future developed devices.

In the preferred embodiment, the user 17 is required to use a type of software called a “browser” as designated by a reference numeral 38. The browser 38 is used to render content that is received from a source, such as the servers 22. In the modern vernacular, a “browser” refers to a specific implementation called a Web browser. Web browsers are used to read and render HTML/XHTML content that is generated when requesting resources from a web server. In the preferred embodiment, the procurement and sourcing tool 10 is designed to be compatible with major Web browser vendors such as Microsoft Internet Explorer, Netscape Navigator, Mozilla, Safari and Opera. However, other embodiments may wish to focus on one particular browser depending upon the common user base connecting to the servers 22.

### 1. Overview of the Function of the Procurement and Sourcing Tool

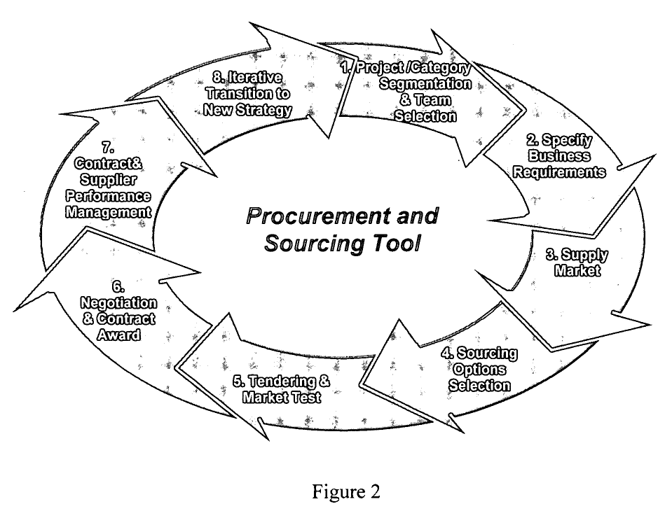

FIG. 2 is a general diagram describing an exemplary work process of the procurement and sourcing tool 10. The procurement and sourcing tool 10 is preferably implemented as a software application that utilizes a multi-step process, such as an 8-step process, including selecting category segmentation and team(s); specifying business requirements; analyzing supply market(s); selecting sourcing options; tendering and market testing; negotiating contracts and contract awards; managing the start up of contract(s) and supplier performance; strategies for transitioning to new strategies. In general, steps 1-6 guide the user through strategy development (the procurement process) and in steps 7-8 the procurement and sourcing tool 10 assists the user in contract and supplier performance management (the supply management process). As will be described in more detail below, the procurement and sourcing tool 10 is preferably designed as an expert system that provides automatic recommendation of strategic sourcing options, that provides information to project and management teams to assist them in the procurement and sourcing process. In a preferred embodiment, the procurement and sourcing tool 10 is provided with a variety of user selectable analysis levels for each purchase item or category of purchase item. The analysis levels are referred to herein and illustrated in the drawings by way of example as “Expedite”, “Lite”, “Professional” and “Full” where the Professional analysis level includes more analysis than the Lite analysis level, and also where the “Full” analysis level provides more analysis than both the Lite and the Professional analysis levels. The “Expedite” level of analysis (i.e., no analysis) can be used if a single or sole source supplier is identified, or if an existing contract is to be used or amended, or if there is no time available to undertake analytical tasks. The “Lite” level of analysis is recommended to be used when the purchase item is of particularly low value or with respect to non-critical categories of spend. Thus, for example, it may be beneficial to conduct a Professional or Full level of analysis for an important costly purchase item, such as a multi-billion dollar capital project while a Lite level of analysis may be appropriate for a low cost purchase item, such as stationary or envelopes.

Throughout the steps, the procurement and sourcing tool 10 also preferably provides (1) best practice sourcing training modules, with early warnings of potential sourcing issues and competence prompts; and (2) a contract repository of the agreed contracts and contract terms to implement the procurement and sourcing strategies with selected suppliers. A detailed description of the individual steps is provided below.

### Step 1—Category Segmentation and Team(s)

The category segmentation and team(s) step allows organizational business units and cost/spend categories to be defined, segmented and stored while also providing for the analysis of purchase items to determine how to logically segment and group the current spend categories, as well as to determine the criticality of particular purchase item(s) to the organization. The goal is to create categories to combine like items into large groupings, when possible, to help with maximizing leverage when negotiating with suppliers. By maximizing the purchase of similar items from the same supplier, the organization is often able to negotiate better pricing and service levels from that supplier than if items are purchased from multiple suppliers. The tool also provides for dis-aggregation options and prompts users to think carefully about what is the correct level of aggregation and dis-aggregation when defining sourcing categories for which to develop strategies. A further embodiment of the present invention provides for assigning individuals from the sourcing and procurement team to manage specific purchase item segments, as well as for defying stakeholder communication strategies. To accomplish the category segmentation, the procurement and sourcing tool 10 collects data from the one or more user devices 18 regarding the segmentation of the organization based on a variety of factors, such as the organization's regional divisions, and/or data regarding spend categories in the form of purchase items. In one embodiment, the users 17 can further provide detailed explanations and comments for each purchase item.

In step 1, the criticality of the purchase item is assessed and initial aggregation and dis-aggregation opportunities are assessed. This can be accomplished by the procurement and sourcing tool 10 presenting a variety of questions or “competence prompts” to the user 17 and then recording the user's answers to the questions. For example, the questions or competence prompts are preferably directed to illicit information from the user to determine purchase item criticality based on various types of criticality, such as technical and/or operational criticality versus commercial and/or mission criticality. Technical and/or operational criticality is defined as an indication of the importance of the purchase item for technical and/or operational success of the organization. Commercial criticality is defined as an indication of the importance of the purchase item for the commercial success of the organization. Mission criticality is defined as an indication of the importance of the purchase item to the strategic mission or goals of the organisation (and especially when the organisation is a public body that does not pursue revenue enhancement and profitability goals).

Once the user's answers are recorded, the procurement and sourcing tool 10 analyzes the user's answers to provide a criticality recommendation indicative of the criticality of the purchase item to the organization as well as a recommended level of further analysis of demand and supply variables and conditions (e.g., “Expedite”, “Lite”, “Professional” and “Full”) based upon the criticality of the purchase item to the organization. For example, the servers 22 can generate for each of the purchase items a criticality value selected from the group consisting of strategic critical, strategic, tactical critical or tactical, based on the data collected from the user. Strategic critical/strategic is defined as the relative importance of the purchase item for commercial and/or mission delivery success of the organization (high or low). Tactical critical/tactical is defined as the relative importance of the purchase item for operational sustainability and delivery (high or low). Purchase items of different criticality value will preferably undergo different levels (expedite, lite, professional or full) of analysis in the following steps of the process. The tool does not prescribe the analysis, but merely recommends the level of analysis that ought to be undertaken for each type of criticality value: Strategic Critical (full analysis)/Strategic and Tactical Critical (professional)/Tactical (lite). The user of the tool decides whatever level of analysis is feasible, and the tool records the level of analysis recommended and the level of analysis undertaken, so that the work undertaken by the user can be audited in the future. In one embodiment of the present invention, answers to questions in a simpler version are stored and used in a more complex version. For example, to carry out a full version analysis, questions in the lite version must be answered first, and then questions in the professional version, before the servers 22 will allow the user 17 to proceed to the full version analysis. In one embodiment of the present invention, the user 17 can choose an expedite level of analysis instead of the recommended level of analysis based on the criticality value because there is a sole source of supply, an existing contract is to be used or amended, there is no time to carry out the analysis, or for other reasons.

In one embodiment of the present invention, for each activity and task and each question asked in step 1, a help tool with competence prompts is provided to train and develop the competence of users.

### Step 2—Specifying Business Requirements, i.e., Demand Analysis

In the second step of the process, the procurement and sourcing tool 10 prompts the strategy team (1) to understand the compliance requirements of the organization, (2) to define the high-level business requirements of the spend category, and (3) to define the technical and commercial requirements for the spend category. This may include: analysis of the organization's business needs; the likely benefit to be derived from sourcing a particular purchase item; and, the ease with which a given purchase item benefit can be achieved. This analysis will assist with determining what the sourcing strategy will be for each purchase item and how the sourcing efforts for each spend category will be sequenced.

First, the tool prompts users to define and collect purchase item data and supply item data from the one or more user devices. Purchase item data includes one or more purchase items, purchase item criticality collected in step 1, and baseline values of key procurement and sourcing business criteria for each of the purchase items. Examples of business criteria include, but are not limited to, technical competence (including delivery options, functionality and relationship types), commercial congruence (including total cost of ownership, i.e., the total expected costs to procure a given item including, for example, the price of the item, the costs associated with the ability to design and develop an item, warehousing and logistics costs, the cost of internal process and operations, and the costs of disposal). Technical competence is an indication of the technical suitability of the given item. Commercial congruence is an indication of the commercial suitability of the given item.

The user describes and defines the baseline values they wish to procure against these business criteria for one initial technical option (purchase item), and then (if required) alternative values for the same group of business criteria are collected for one more, or a plurality of, proposed supply items (alternative technical options), that can be purchased to perform the functions of the proposed purchase item. This is achieved by the user defining the procurement and sourcing business criteria (technical competence and commercial congruence) for the alternative technical option(s) relative to those defined in the baseline value proposition (initial technical option), using the same method as used for defining and collecting the baseline value proposition (initial technical option). This data including one or more supply items and values of procurement and sourcing business criteria for each of the supply items is collectively called supply item data.

Based on inputs from these business criteria, the servers 22 generate one or more item positioning plots in a format suitable for graphical display to demonstrate the baseline value proposition (the initial technical option, whose technical and commercial values always place it in the mid-point of the graphical display(s)), and, if alternative technical options have been selected, all (or selected ones) of the alternative technical options are displayed (plus or minus) relative to the technical competence and commercial congruence values of the baseline value proposition (initial technical option) for the purchase item. All (or selected) alternative technical options are placed relative to the baseline value proposition (the initial technical option at the mid-point of the graphical display) based on technical suitability and commercial suitability in at least four regions: high competence/high cost, high competence/low cost, low competence/high cost, and low competence/low cost.

In one embodiment of the present invention, after reviewing the technical competence and commercial congruence display, the procurement and sourcing tool 10 prompts the user to select one, or a number, of technical options to collect demand market data indicative of their demand impacts on the supply market and/or on a supplier or suppliers. This is done in order to assist with the determination of, in relation to the supply market and/or a supplier or suppliers, the current and future power and leverage position of the buying organization; the current and future competitive forces in the market; the current and future attractiveness of the buyer's business; the current and future relationship and performance management approach desired by the buyer; and, the current and future position of the purchase item in the purchasing portfolio and sourcing portfolio matrices. This demand-side power and leverage analysis helps the user to understand in detail the key demand levers available for the buyer in their relationship with the supply market and suppliers. This in turn provides the basis for the tool to provide later in step 4 (after a similar analysis has been undertaken in step 3 of the supply-side power and leverage resources available to suppliers in the supply market) an indication of the current and future appropriateness of different sourcing strategies and tactical contractual levers/options (using a traffic light system—based on red (not appropriate), amber (may be appropriate) and green (appropriate)).

Analysis of the demand-side power and leverage resources available to the buying organization can be carried out at different levels of detail and complexity such as expedite, lite, professional or full, depending on the criticality value of the purchase item and/or information available. Data related to the demand-side power and leverage analysis is stored in the tool, but additional information and analyses of demand related variables can also be stored in a knowledge management module. For example, in the lite version of demand analysis, for each of the selected supply items, data about market position (including the current number of buyers of a supply item, the anticipated future number of buyers of the supply item, the organization's current proportional share of total market demand for the supply item, the organization's anticipated future proportional share of total market demand for the supply item), the structure of the organization's anticipated demand, position in the market, and sourcing levers and options are collected. Additional data about the demand-side power and leverage resources, such as whether market demand and supply is in equilibrium, what is the total expenditure for the purchase item, or whether the organization buy this item with other buyers internally or in a buyer's club, will be collected in the pro version or the full version.

In one embodiment of the present invention, for each activity and task and each question asked in step 2, a help tool with competence prompts is provided to train and develop the competence of users.

### Step 3—Supply Market Analysis

In step 3, the procurement and sourcing tool 10 assesses demand market data indicative of the current and future supply-side power and leverage resources available for the supply market and/or a supplier or suppliers in relation to the buyer for each of the purchase item(s). In this regard, data regarding the supply market and/or supplier(s) for the purchase item(s) are collected from the one or more user devices 17 and are stored in the tool, but additional information and analyses of supply related variables can also be stored in a knowledge management module. This is done to assist with the determination of: the current and future power and leverage position of the buying organization; the current and future competitive forces in the market; the current and future attractiveness of the buyer's business; the current and future performance management approach desired by the buyer; and the current and future position of the purchase item in the purchasing portfolio and sourcing portfolio matrices. This supply-side power and leverage analysis helps the user to understand in detail the key supply levers available for the supply market and/or a supplier or suppliers their relationship with the buying organization. This in turn provides the basis for the tool to provide later in step 4 (after this analysis has been linked with the earlier demand-side power and leverage analysis in step 2) an indication of the current and future appropriateness of different sourcing strategies and tactical contractual levers/options (using a traffic light system—based on red (not appropriate), amber (may be appropriate) and green (appropriate)).

Analysis of the supply-side power and leverage resources can be carried out in different levels such as lite, professional or full, depending on the criticality value of the purchase item and/or information available. For example, in the lite version of the supply market analysis, data about market overview (including the current number of suppliers of a supply item, the anticipated future number of suppliers of the supply item, the current number of capable suppliers of the supply item, and the anticipated future number of capable suppliers of the supply item), the structure of the supplier(s) anticipated supply market capacity and capability, position in the market, and supply item levers and options are collected. More detailed questions about supply-side power and leverage resources in the supply market and/or for a supplier or suppliers, such as how the organization's spending is divided between the suppliers, market size, or external issues with an impact on the supply market, are prompted in the professional or full versions of supply market analysis.

In addition to the generic supply market analysis of supply-side power and leverage resources, the user 17 can choose to take a supplier analysis about individual pre-approved suppliers for the purchase item or supply items. Analysis of the suppliers can also be carried out in different levels such as lite, professional or full, depending on the criticality value of the purchase item and/or information available. For example, in the lite version of supplier analysis, for the purchase item and the selected supply items, data about market position (including share of spending a particular supplier receives), market configuration, sourcing issues, market overview, market structure, and supplier relationship are collected. More detailed questions about the supplier(s), such as how the organization's spending is divided between the suppliers, whether market demand and supply is in equilibrium, total expenditure from the organization, or external issues with an impact on the supplier, are asked in the professional or full version supplier analysis.

In one embodiment of the present invention, for each activity and task and each question asked in step 3, a help tool with competence prompts is provided to train and develop the competence of users.

### Step 4—Sourcing Options

In step 4, the procurement and sourcing tool 10, based on the data about the demand-side and supply-side power and leverage resources, the servers 22 automatically generate a variety of analyses (presented in graphic displays and plots in relation to the supply market and/or a supplier or suppliers) of the current and future power and leverage positions of the buying organization; the current and future competitive forces in the market; the current and future attractiveness of the buyer's business; the current and future relationship and performance management approach desired by the buyer; and, the current and future position of the purchase item in a purchasing portfolio matrix and in a sourcing portfolio matrix. These demand and supply side power and leverage analyses and plots help the user to understand in detail the key demand levers available for the buyer in their relationship with the supply market and suppliers; and the supply levers available to supplier(s) in the supply market. The tool also provides an indication of the current and future appropriateness of different sourcing strategies and tactical contractual levers/options (using a traffic light system—based on red (not appropriate), amber (may be appropriate) and green (appropriate)). To create the current and future analyses and plots the tool assigns numerical values to each of the answers provided by users to the current and future questions provided in steps 2 about the demand-side power and leverage resources, and in step 3 about supply-side power and leverage resources. These numerical values are then used to automatically to assign current and future positions and plots in the graphical displays for the buyer in relation to the supply market and/or a supplier or suppliers. In one embodiment of the present invention, based on the data about the demand market and supply market, the servers 22 generate a variety of graphic displays with respect to the current and future power and leverage positions of the buyer in relation to the supply market and/or a supplier or suppliers for each of the technical options (supply items) individually.

In one embodiment of the present invention, based on the data about the demand market and supply market, the servers 22 generate market positioning data and provide the market positioning data in a format suitable for graphical display as one or more market positioning plots with respect to the current and future attractiveness of the buyer's account for its suppliers for each of the technical options (supply items) individually.

In another embodiment of the present invention, all supply items for a certain purchase item are placed in a single graphic display of one or more market positioning plots.

Examples of these market positioning plots include, but are not limited to, a power matrix, a competitive force analysis, a supplier positioning matrix, a performance management matrix, a purchasing portfolio analysis, and a sourcing portfolio analysis. Market positioning plots includes a plurality of delineated regions such that the position of a given item within one of the plurality of regions is indicative of one or more characteristics of the market relationship between the organization and the seller on the given item.

A power matrix displays the organization's power and leverage resources in buyer/seller exchange relative to the supplier's power in buyer/seller exchange in at least four regions: a buyer dominance region, an interdependence region, a supplier dominance region, and an independence region. In one embodiment of the invention, the servers 22 can display answers provided in previous supply market analysis, and/or supplier analyses that will affect the organization's power in buyer/seller exchange.

A competitive force analysis displays the competitive forces impacting on the supplier(s) for the supply items in at least five regions: a buyer power region, a supplier power region, a threat of substitution region, a supplier competitive position region, and a threat of new entrants region.

A supplier positioning matrix displays the attractiveness of the organization's account relative to the profitability of the organization's account to the suppliers in at least four regions: a development account region, a key account region, an irritation account region, and an exploitation account region.

A performance management matrix displays the amount of collaboration (arm's length transaction, partial collaboration, or full collaboration) required relative to the commercial value distribution between the organization and the suppliers (supplier maximizing, satisfying, or buyer maximizing) in at least nine regions: a full collaboration/supplier maximization region, a full collaboration/satisfying region, a full collaboration/buyer maximization region, a partial collaboration/supplier maximization region, a partial collaboration/satisfying region, a partial collaboration/buyer maximization region, an arms length/buyer maximization region, an arms length/satisfying region, and an arms length/supplier maximization region.

A purchasing portfolio analysis automatically displays the nature of the supply market into two categories (easy or difficult) relative to the criticality of the purchase item into two categories (high/low). This provides for four regions for positioning of the supply market and/or supplier(s): a bottleneck region, a strategic region, an acquisition region, and a leverage region. The appropriate sourcing strategies to adopt in each of these 4 regions are outlined in a help tool with competence prompts.

A sourcing portfolio analysis displays the nature of the supply market relative to the criticality of the purchase item, (i.e. the purchasing portfolio analysis, but in a more sophisticated manner), dividing the criticality of the purchase item into 4 categories (tactical/tactical critical/strategic and strategic critical) and the nature of the supply market into four categories (supplier dominance/interdependence/independence/buyer dominance). This provides 16 regions for positioning of the supply market and/or supplier(s): tactical dependence/tactical critical dependence/strategic dependence/strategic critical dependence/tactical alliance/tactical critical alliance/strategic alliance/strategic critical alliance/tactical market/tactical critical market/strategic market/strategic critical market/tactical leverage/tactical critical leverage/strategic leverage/strategic critical leverage. The appropriate sourcing strategies to adopt in each of these 16 regions are outlined in a help tool with competence prompts.

In one embodiment of the invention, the servers 22 utilize an expert system to select one or more suggested sourcing strategies from a database of six pre-defined sourcing strategies (insourcing/joint ventures/supplier selection/supply chain sourcing/supplier development/supply chain management) based on the current and future suitability of each sourcing strategy to the current and future power and leverage resources available to both the buyer and supplier, the competitive forces impacting on the supplier(s) for the supply items, the attractiveness of the organization's account relative to the profitability of the organization's account to the suppliers, the amount of collaboration required relative to the commercial value distribution between the organization and the suppliers, the nature of the supply market relative to the criticality of the purchase item, and/or sourcing portfolio analysis for each of the supply items for each proposed technical option.

In another embodiment of the invention, the servers 22 utilize the expert system to determine the current and future appropriateness of the six different sourcing strategies in the database based on the power in buyer and supplier exchange of the organization, the competitive forces impacting on the supplier(s) for the supply items, the attractiveness of the organization's account relative to the profitability of the organization's account to the suppliers, the amount of collaboration required relative to the commercial value distribution between the organization and the suppliers, the nature of the supply market relative to the criticality of the purchase item, and/or sourcing portfolio analysis for each of the supply items.

An expert system is defined as a software system that attempts to reproduce the performance of one or more human experts.

Sourcing strategies are procurement and supplier relationship and performance management strategies. Examples of sourcing strategies include, but are not limited to, supplier development, supply chain management, supply chain sourcing, insourcing, joint venture, and supplier selection. Each sourcing strategy is provided with appropriateness/feasibility data indicative of the relative appropriateness/feasibility of each sourcing strategy. Sourcing strategies can be further refined depending on whether they will be accepted by the organization, for example, whether insourcing or joint venture is appropriate for the organization, or whether there is human, structural, or technical barriers to the adoption of any sourcing strategy.

In one embodiment of the present invention, different sourcing strategies are provided with current and future appropriateness/feasibility data. In another embodiment of the present invention, for each sourcing strategy, tactical contractual levers/options to carry out the sourcing strategy are also provided with appropriateness/feasibility data indicative of the relative current and future appropriateness/feasibility of each tactical contractual lever/option.

For example, tactical contractual levers/options for supplier selection include, but are not limited to, internal demand management/internal process improvement/external supply management/external process improvement levers/options. Exemplary internal demand management tactical contractual levers/options can be, but are not limited to, volume levels (including stop buying completely, stop buying temporarily, reduce overall volume, increase overall volume, aggregate volumes, consortia aggregation, bundle volumes with other requirements, use other deals within the business, disaggregate volumes, and lot optimization); design and specification levers (control of maverick spend, standardize requirements, rationalize product/service lists, increase specifications, decrease specifications, minimize frequency of specification changes, joint research and development, joint design and specification); and demand management levers (early volume commitments, demand smoothing, advanced demand forecasting, design and specification prioritization, long-term volume commitments, framework agreements). Exemplary internal process improvement tactical contractual levers/options can be, but are not limited to, internal value and process optimisation strategies (agile and/or lean). Exemplary external supply management tactical contractual levers/options can be, but are not limited to, supply market levers (sole source, decrease number of suppliers, single source, increase number of suppliers, dual source, multiple source, move volumes pre and post-contractually, define volumes pre and post-contractually post-contractual competition, should cost/best price evaluation, price benchmarking, reverse auction, e-optimisation), and contractual levers (spot, 30 days, 1-3 months, 4-6 months, 7-11 months, 1 year, 18 months, 2 years, 2-3 years, 3 years, more than 3 years, standard contracts, bespoke contacts, incremental pricing, decremental pricing, early settlement discounts, volume discounts, rebates, intellectual property tights, exit strategies, performance incentives, performance penalties, service level agreements, open book agreements, joint process optimisation, invoice audit, price and commodity hedging, currency arbitrage, local content, counter trade). Exemplary external process improvement tactical contractual levers/options can be, but are not limited to, external value and process optimisation strategies (agile and/or lean).

In one embodiment of the present invention, procurement and sourcing strategies are provided with data indicative of potential opportunities for benefits and potential risks and a market testing prioritization methodology is provided with in which the user 17 can specify weighting values associated with potential opportunities for benefits and potential risks. A variety of potential opportunities for benefits and potential risks can be analyzed, such as benefits (including functionality, delivery, and cost), risks (including functionality, delivery, and cost), corporate goals (including revenue generation, mission criticality, local content and reciprocity), cost to implement, and time to implement. After the sourcing options and the weighting factors for these outcomes are recorded by the procurement and sourcing tool 10, the servers 22 generate a prioritization table according to the weighting values to rank all potential procurement and sourcing strategies demonstrating an improved appropriateness/feasibility with all tactical contractual levers/options demonstrating an improved appropriateness/feasibility. In another embodiment of the present invention, after the organization selects appropriate procurement and sourcing strategies with relevant tactical contractual levers/options for market testing with suppliers, the servers 22 generate a prioritization positioning matrix to rank order selected suppliers for each of the procurement and sourcing strategies with selected tactical contractual levers/options for each technical option. This is achieved by the user 17 evaluating selected potential supplier(s) for market testing against the baseline value proposition for the technical sourcing option being evaluated (defined in terms of the technical competence and commercial congruence business criteria selected for each sourcing option). Based on the analysis of the potential suppliers' current competence and congruence against these business criteria by the user 17 a competence/congruence positioning plot shows the expected performance of each potential supplier for each sourcing strategy (with its tactical contractual levers/options, relationship management and performance management options). The user 17 can then select which of the potential suppliers to take forward for a formal market test in step 5, prior to final supplier(s) selection and contract award in step 6. And supply item performance data for one or more supply items generated in this pre-evaluation process is stored in the procurement and souring tool.

In one embodiment of the present invention, for each activity and task and each question asked in step 4, a help tool with competence prompts is provided to train and develop the competence of users.

### Step 5—Market Test

After the user 17 selects procurement and sourcing strategies and options and supplier(s) that the organization wishes to test in the market, a bid evaluation methodology is first developed. The bid evaluation methodology includes a bid schedule, an evaluation plan with specific steps, and assessment and scoring methodology used for evaluation. Before the start of the bid process, existing contracts will be reviewed and examined. The process of bid will be documented in bid documentation. All the bids received will be documented and evaluated, and suppliers will be plotted on a competence and congruence plot based on the values they submit in their bids. Based on the competence and congruence plot, supplier(s) will be chosen for negotiation and/or final supplier selection. And supply item performance data for one or more supply items generated in this formal market test process is stored in the procurement and souring tool.

In one embodiment of the present invention, for each activity and task and each question asked in step 5, a help tool with competence prompts is provided to train and develop the competence of users.

### Step 6—Negotiation and Contract Award

Following strategies suggested by the procurement and sourcing tool, negotiation with selected supplier(s) is performed. After negotiation, the value proposition for the sourcing strategy is recalibrated and the tool provides access to model contracts or allows modification of existing contracts to use in the contract award process. The tool also provides a structured process for signing-off and awarding contracts. After contract award, key contract data of a contract, such as values and expiration date, is stored in a contract repository module held in step 7 of the process to assist the management of the contract. For example, when a contract is due for expiry, a notice will be sent to the management team automatically. The contract repository module stores all existing contracts to provide secure internet access to these contracts regardless of physical location.

In one embodiment of the present invention, for each activity and task and each question asked in step 6 a help tool with competence prompts is provided to train and develop the competence of users.

### Step 7—Contract Start Up & SPM

After the award of a contract to a supplier or suppliers, supply item performance data (based on pre-contractually agreed and negotiated performance expectations) are collected and entered into the tool for each of the supply items contracted from the one or more user devices 18. The data for each contract is also stored in a supplier relationship management module. Examples of supply item performance data include, but are not limited to, technical competence and commercial congruence such as quality, delivery, relationship and total cost of ownership.

In addition to supply item performance date, supplier performance data indicative of the performance of one or more suppliers relative to predefined performance expectations is collected by the servers.

Based on the supply item performance data and/or supplier performance data, the servers 22 generate data to compare the performance of a supplier in difference organization segmentations and/or performance of all suppliers in the organization.

In one embodiment of the present invention, the servers 22 generate relationship management options at the organization to supplier level rather than at the purchase item to supply item level. Exemplary relationship management options can be, but not limited to, a gold relationship management standard and approach, a sliver relationship management standard and approach, a bronze relationship management standard and approach, and a keep in touch relationship management standard and approach. These standards define the levels of corporate involvement (from Chairman and CEO to lowest level employees) and the frequency and scale and types of meetings and interaction for each supplier.

The servers 22 also collect organization-performance data from the one or more user devices and generates data indicative of the performance of the organization's staff in performing procurement strategy activities relative to predefined performance expectations to allow the organization to compare the performance of the organization over time. In particular, the tool provides a comparison of the recommended levels of analysis and work activities for each category of spend and the actual level of analysis and work activity actually undertaken by the strategy team. The tool also provides an analysis of the objectivity of data collected and to what extent analysis involves guesstimates and don't knows. In one embodiment of the present invention, the servers 22 generate performance management options indicative of actions to be performed on the organization-performance data, the actions selected from the group consisting of: data management actions and data reporting actions.

In one embodiment of the present invention, for each activity and task and each question asked in step 7, a help tool with competence prompts is provided to train and develop the competence of users.

### Step 8—Iterative Transition to New Strategy

In the events of contract breach, contract expiration, or an early closure of a contract, the procurement and sourcing tool provides a process for contract closure and feedback with suppliers, with competence prompts about whether to renegotiate, re-award the contract, terminate the contract, use a different strategy, or reanalyze the demand and supply market to generate new procurement and sourcing strategies. Following these suggestions, the user 17 will be redirected to related steps in the procurement and sourcing tool 10.

In one embodiment of the present invention, for each activity and task and each question asked in step 8, a help tool with competence prompts is provided to train and develop the competence of users.

### Competence Development and Knowledge Management

Throughout all the steps, the servers 22 preferably provide competence prompts to the one or more user devices to assist the user 17 to understand the process. The competence prompts can be in format of text, templates, spreadsheets or graphics. In one embodiment of the present invention, the servers 22 provide competence prompts in the format of text windows to display a definition for a term pointed by a pointing tool. In another embodiment of the present invention, the servers 22 provide competence prompts in the format of a data collection process and reporting process with graphical representations to show the opportunity costs and risks as well as an estimated return on investment of pursuing particular opportunities or mitigating particular risks. In another embodiment of the present invention, the servers 22 provide justification (if required) free text drop down boxes to allow the user to explain and justify their answers to questions, reasons for undertaking tasks and activities, and for making decisions. This information is stored in the tool in a knowledge management repository. The tool also provides within a knowledge management repository a store for templates that users might find useful in managing the process and all additional documents uploaded by users throughout each step of the process. The templates provided in the tool include, but are not limited to, the following:
Sourcing Strategy Business Case
Value Proposition Development
RFI
Strategic Source Planning
Make/Buy & Joint Venture Analysis
Pre-qualification Questionnaire
Sourcing Strategy
Purchase Price Cost Analysis

In one embodiment of the present invention, throughout all the steps, the servers 22 provide guidance and training material to the one or more user devices to give the user 17 access to a help tool. In one embodiment of the present invention, the help tool displays the current web page with a list of explanations. The explanations may be dynamically displayed based at least in part on a user input. The explanations may also be based at least in part on an aspect of the status of input from the one or more user devices.

The servers 22 also audit whether the organization's staff, i.e., users 17, followed the recommended level of analysis, whether the staff completed the level of analysis undertaken. The servers 22 also record and audit the objectivity of the data, which questions were unanswered or incomplete, and the justifications for any decisions or actions taken to provide an audit trail of competence and to generate a knowledge management repository of all of the reports, documents and templates used to support the procurement and sourcing process.

### 2. Preferred Embodiment

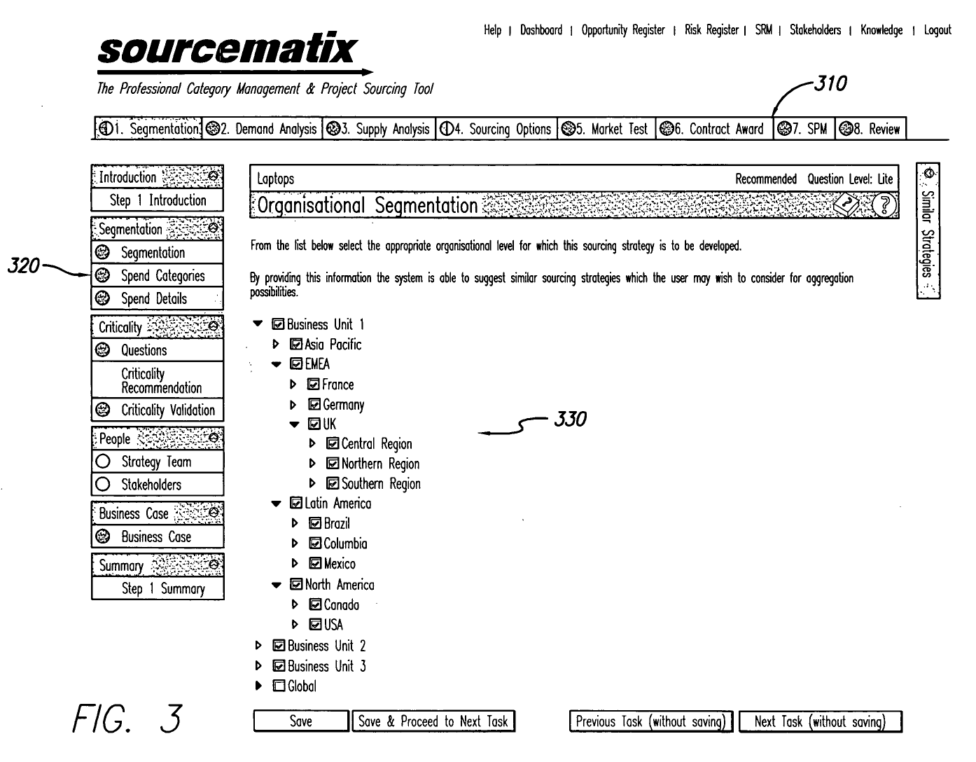

Referring now to the drawings, and more particularly to FIGS. 3-25, shown therein are screen shots or exemplary web pages from a preferred embodiment of the method and procurement and sourcing tool 10 according to the present invention.

FIGS. 3-6 illustrate web pages for the segmentation of the organization's spend categories, as well as the generation of the criticality recommendation regarding specific spend categories. More particularly, FIG. 3 is an exemplary “Organizational segmentation” web page generated by the servers 22 in accordance with the preferred embodiment of the present invention. The organizational segmentation web page guides the user 17 through the initial set up of the organization's sourcing strategy and also assists the user 17 with the segmentation of the category of spend to be analyzed. The web page is provided with a main status tool bar 310 showing that the web page belongs to a step of segmentation within the procurement and sourcing tool, and a task status panel 320 showing the title of the current task within the step. The web page also includes a context body 330 displaying the organization segmentation. The users 17 can select specific segments, e.g., regional divisions that the current sourcing strategy will develop for and apply to. After defining the organizational segmentation, users 17 can choose to save, save and proceed to the next task, back to previous task without saving, or go to the next task without saving.

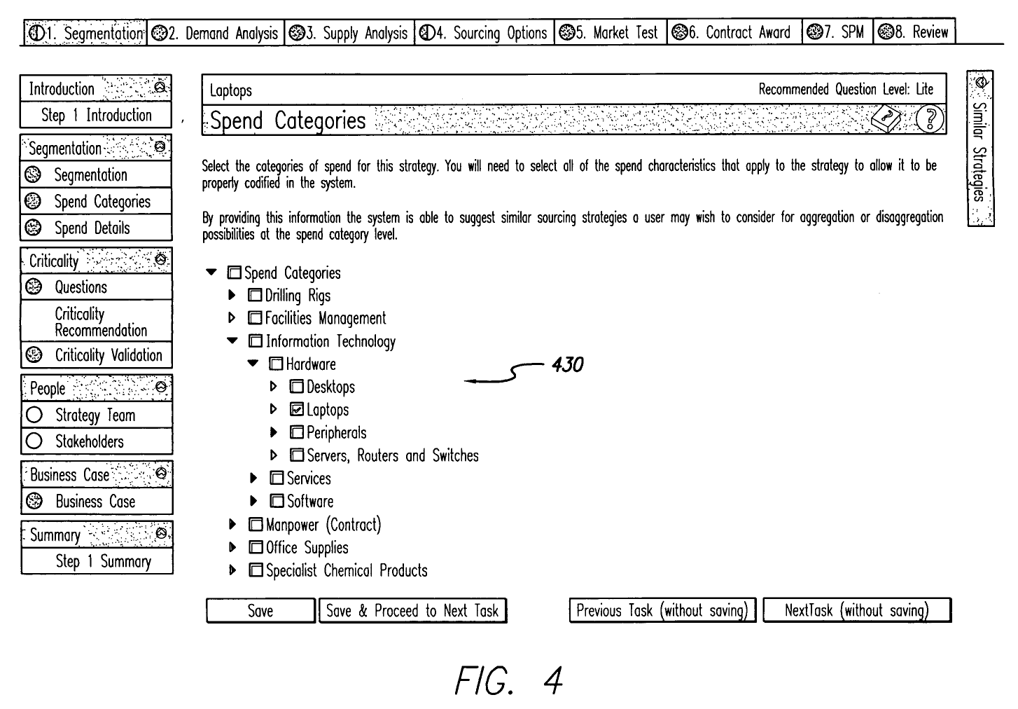

FIG. 4 is an exemplary “Spend Categories” page generated by the servers 22 in accordance with the present invention. The “Spend Categories” page is provided with a context body 430 that displays all spend categories within the organization. The users 17 can select specific spend categories that the current sourcing strategy will develop for and apply to. In the example shown, the user 17 has selected “Laptops” a spend category in which to develop a strategy.

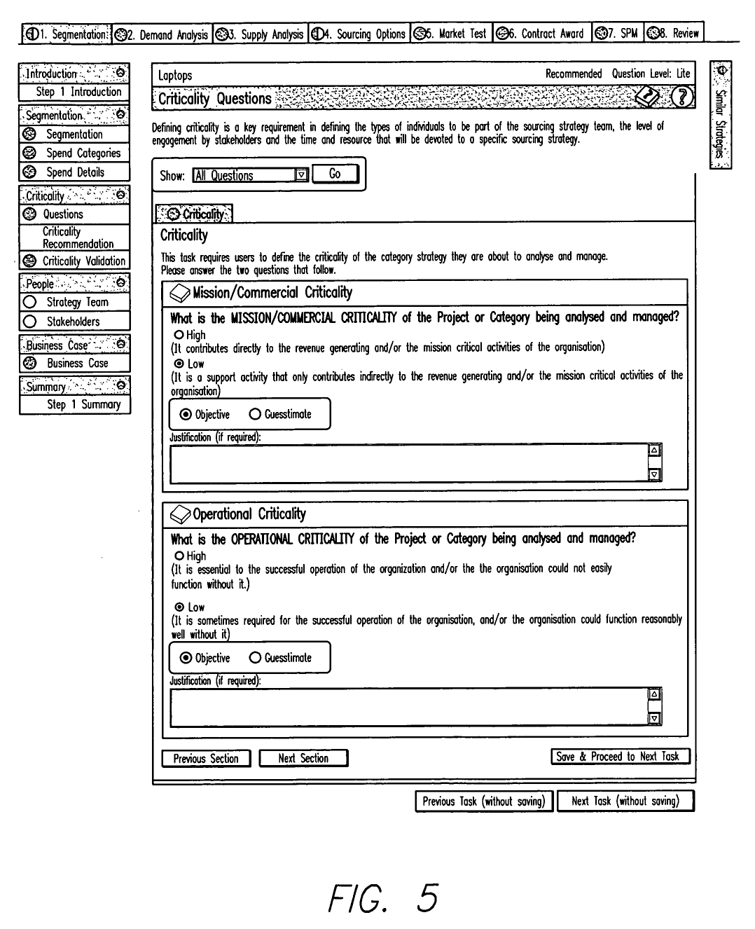

Shown in FIG. 5 is an exemplary “Criticality Questions” page generated by the servers 22 in accordance with the present invention. The “Criticality Questions” page presents criticality questions or competence prompts X & Y about the mission/commercial criticality and the operational criticality of the purchase item. The users 17 can provide objective or guesstimate answers to the criticality questions. In this case, the criticality questions illicit information (shown as the checkboxes A and B) regarding the strategic importance of the spend category or purchase item. In this example, the spend category is “Laptops” and the user 17 has indicated that Laptops (1) is a support activity that only contributes indirectly to the revenue generating and/or the mission critical activities of the organization, and (2) is sometimes required for the successful operation of the organization, and/or the organization could not function reasonably well without it.

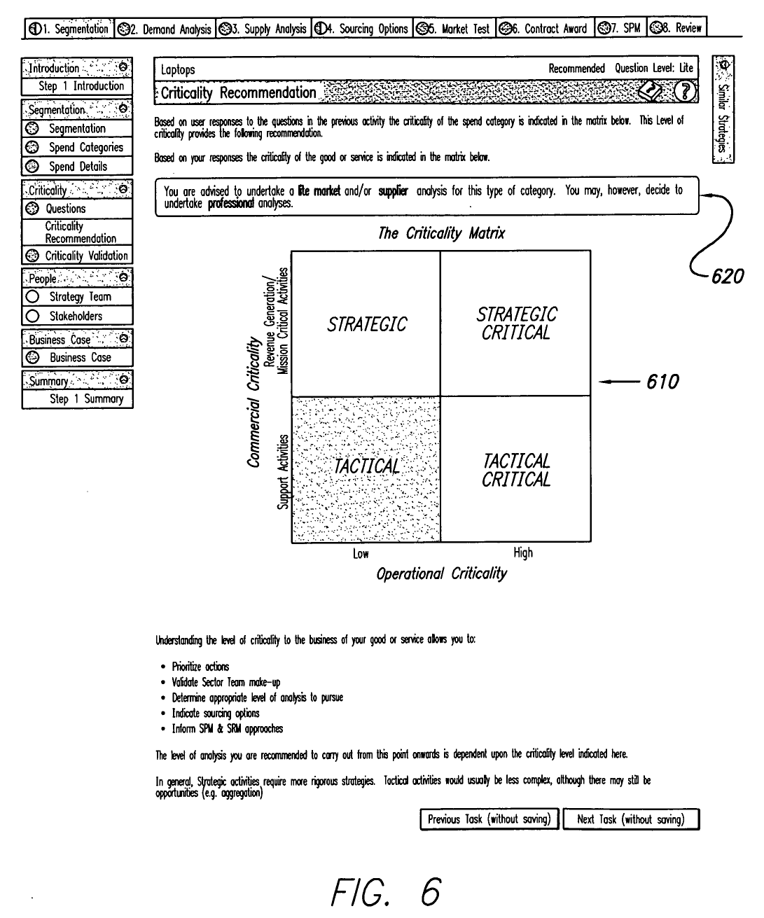

FIG. 6 is an exemplary “Criticality Recommendation” page generated by the servers 22 in accordance with the present invention. Based on information submitted to the criticality questions, the servers 22 generate a criticality matrix 610 to display the determined criticality of the purchase item. An analysis recommendation box 620 is also provided to give suggestions on whether market and/or supplier analysis will undergo lite, professional, or full analysis based on the criticality of the purchase item. The procurement and sourcing tool 10 is designed to permit the user 17 to follow or ignore the suggestions regarding the recommended level of analysis. However, the procurement and sourcing tool 10 records the user's decision to follow or ignore the recommended level of analysis for audit purposes.

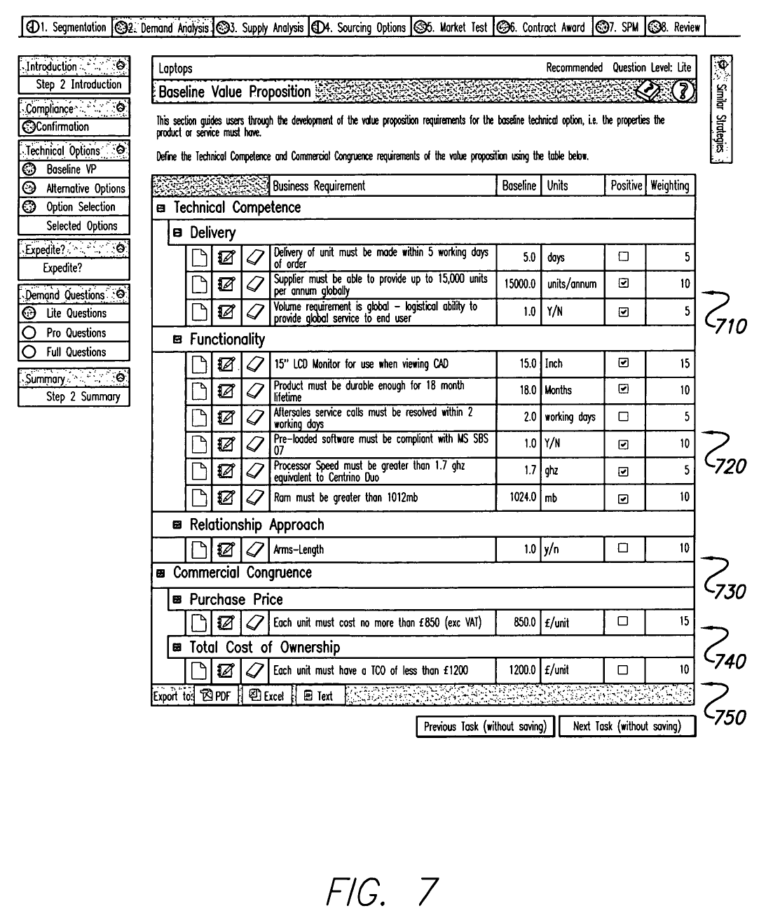

FIGS. 7-10a illustrate exemplary web pages for implementing the second step of the process. As discussed above, the procurement and sourcing tool 10 drives the strategy team (1) to understand the compliance requirements of the organization, (2) to define the high-level business requirements of the spend category, and (3) to define the technical and commercial requirements for the spend category. This may include analysis of the organization's business needs, the likely benefit to be derived from sourcing a particular purchase item and the ease with which a given purchase item benefit can be achieved. This analysis will assist with determining what the sourcing strategy will be for each purchase item and how the sourcing efforts for each spend category will be sequenced.

First, as shown in FIG. 7, an exemplary “Baseline Value Proposition” page is generated by the servers 22 in accordance with an embodiment of the present invention. The “Baseline Value Proposition” page includes a variety of fields for collecting data for baseline business criteria for the purchase item: delivery 710, functionality 720, relationship approach 730, purchase price 740, and total cost of ownership 750. The baseline values of business criteria are collected for each of the purchase items from the one or more user devices. Examples of business criteria include, but are not limited to, technical competence (including delivery options and functionality and relationship), commercial congruence (including total cost of ownership, i.e., the total expected costs to procure a given item including, for example, the price of the item, the costs associated with the ability to design and develop an item, warehousing and logistics costs, and the cost of internal process and operations).

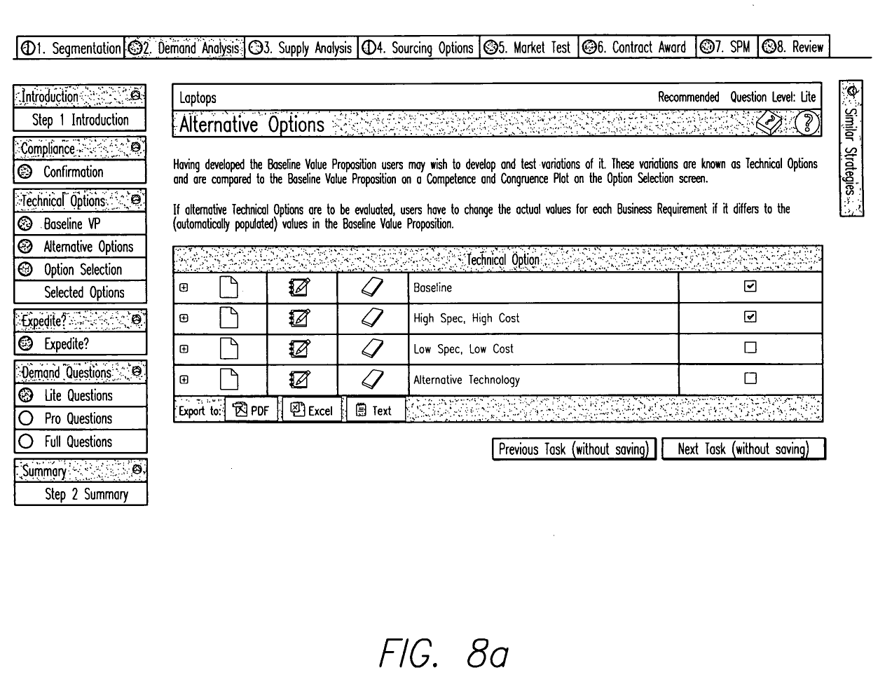

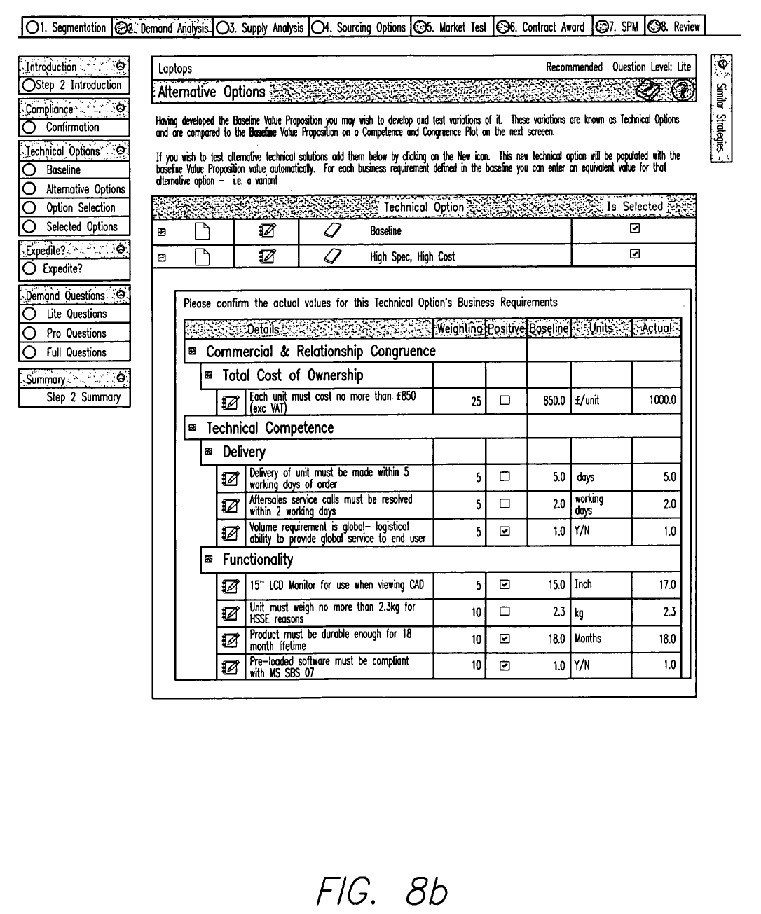

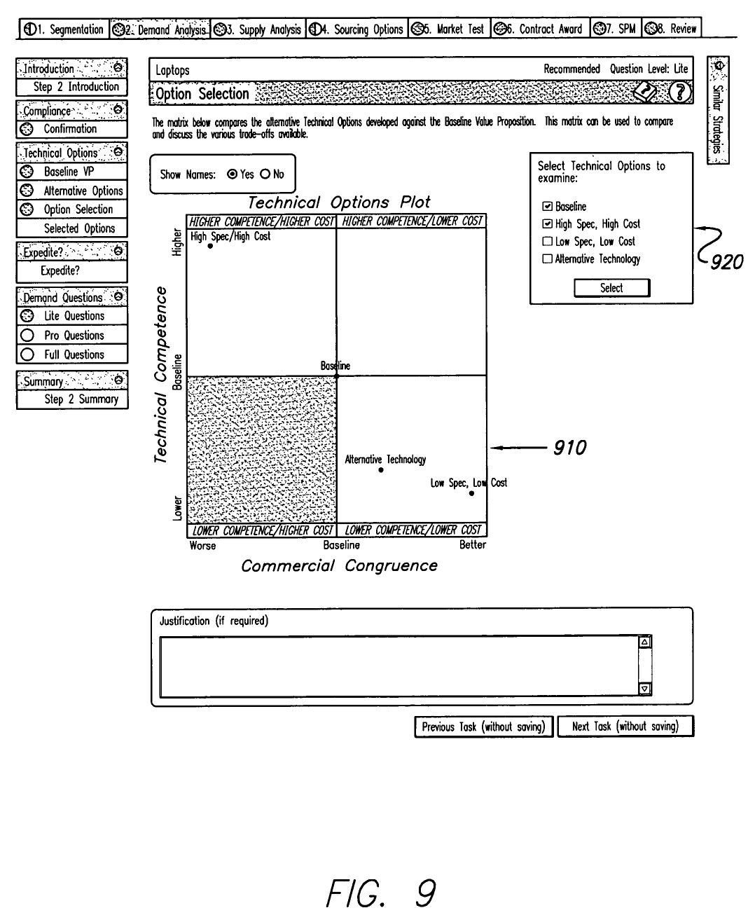

Then, as shown in FIGS. 8a and 8b, alternative options are collected for a plurality of proposed supply items that can be purchased to perform the functions of the purchase item. Based on inputs from these business criteria, the servers 22 generate one or more graphical display(s) to demonstrate all or selected ones of the proposed supply items' technical competence and commercial congruence relative to the purchase item as shown in FIG. 9. FIG. 9 is an exemplary “Option Selection” page generated by the servers 22 in accordance with an embodiment of the present invention. After comparing the supply items against the purchase item on business criteria, the servers 22 generate a technical options plot 910 to plot selected supply item with the purchase item as baseline based on commercial congruence and technical competence. After viewing the technical options plot 910, the user 17 can select technical options to examine in a selection box 920 to proceed with additional analysis.

All (or selected) proposed supply items are placed relative to other proposed supply items and relative to the purchase item in at least four regions: high competence/high cost, high competence/low cost, low competence/high cost, and low competence/low cost. In one embodiment of the present invention, the procurement and sourcing tool 10 prompts the user 17 to select a variety of technical options to examine for the supply items to further analyze their demand impacts after reviewing the technical competence and commercial congruence display. This helps the user 17 to understand in detail the key demand levers available for the buyer in their relationship with the supply market and suppliers.

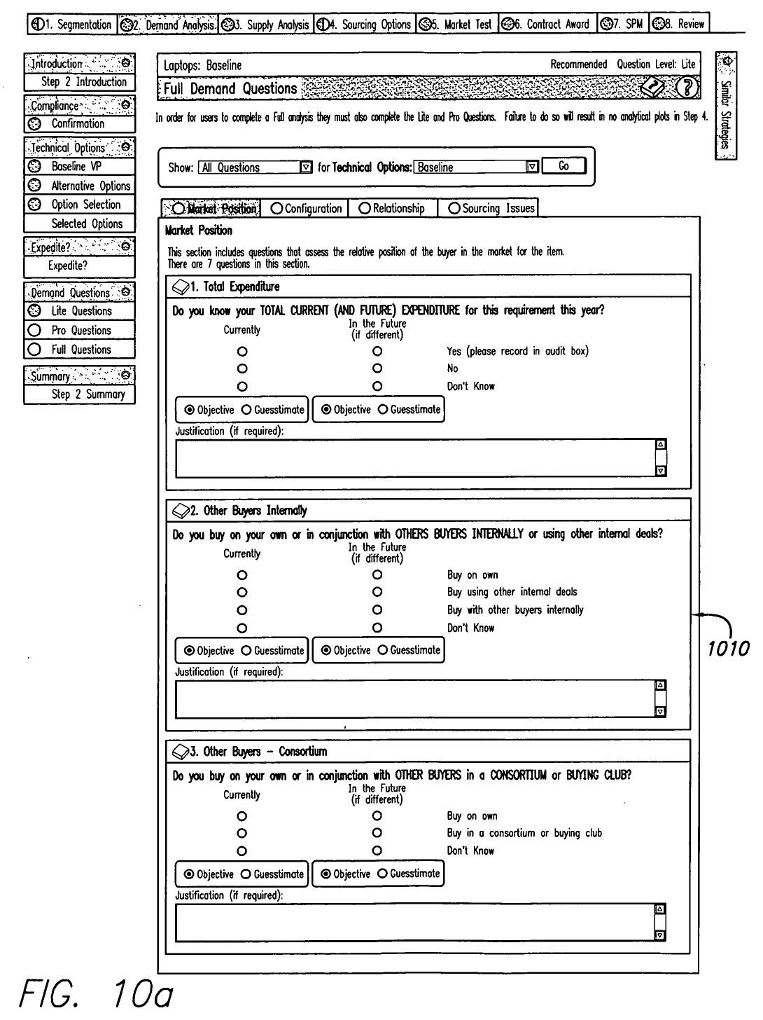

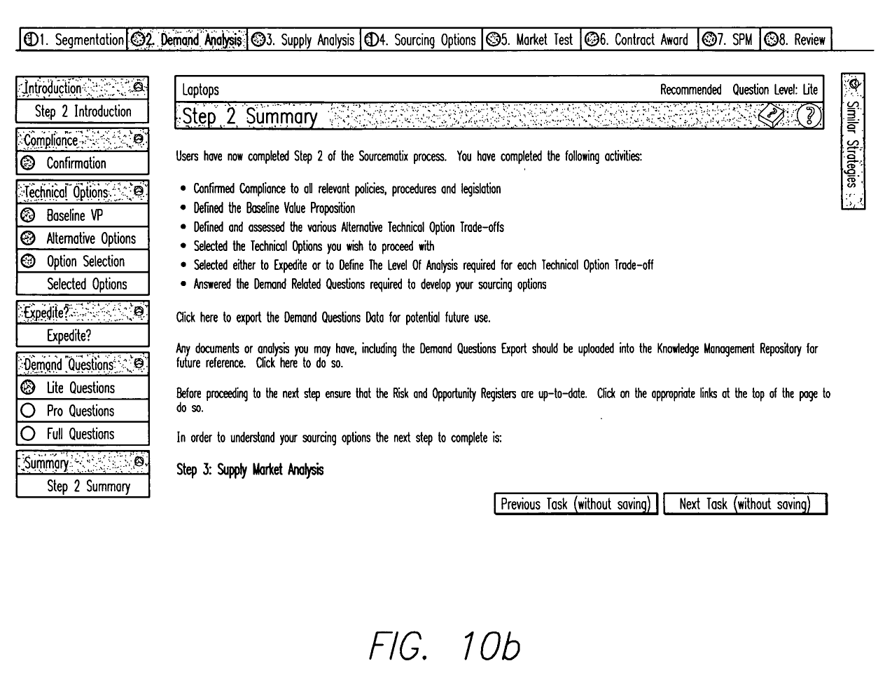

FIG. 10a is an exemplary “Full Demand Analysis” page generated by the servers 22 in accordance with an embodiment of the present invention. The “Demand Analysis” page includes a variety of fields for collecting demand market data 1010 for the purchase item. Examples of such demand market data include, but are not limited to, market position, configuration, relationship, and sourcing issues.

FIG. 10b is an exemplary “Summary” page for Step 2 generated by the servers 22 in accordance with an embodiment of the present invention.

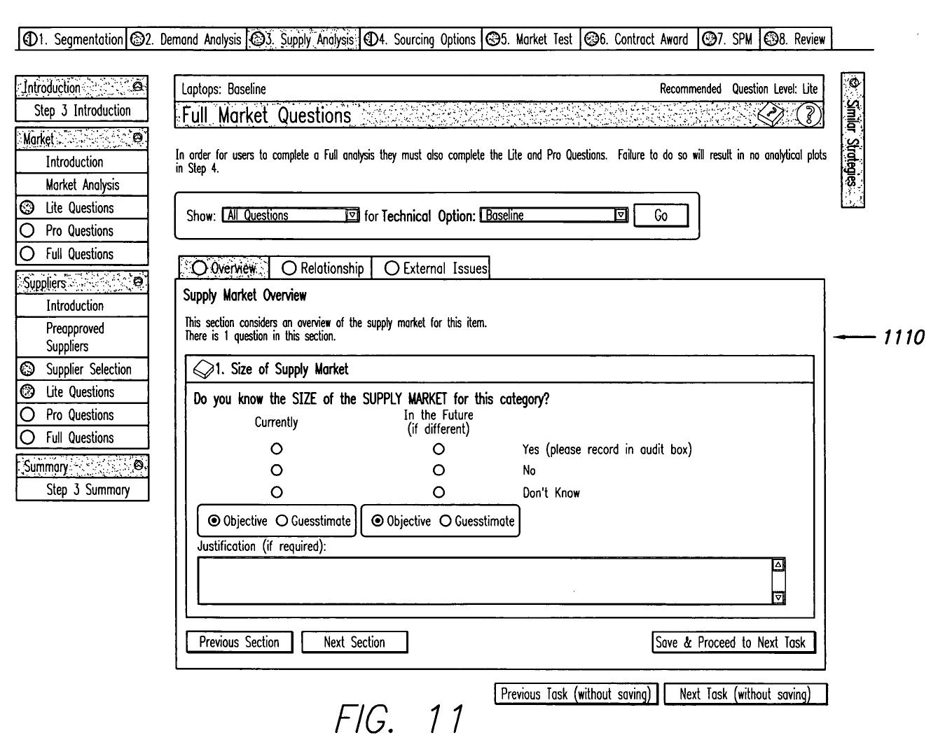

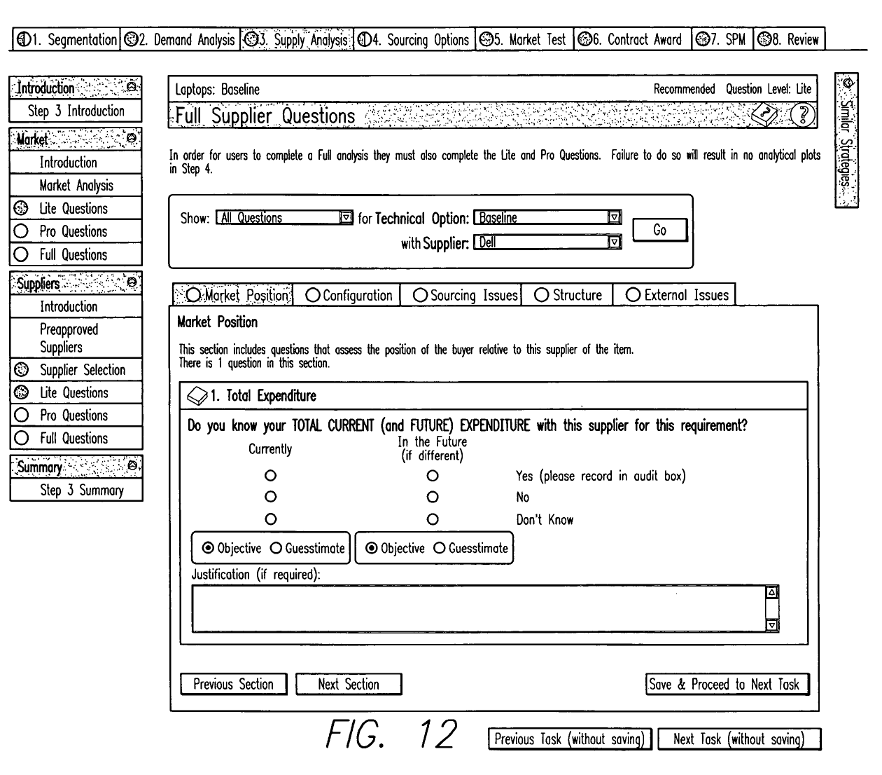

Referring now to FIGS. 11-12, in step 3, the procurement and sourcing tool 10 assesses the current and future situations for the buyer for each of the purchase item(s). In this regard, data regarding the supply market and/or supplier for the purchase item(s) are collected from the one or more user devices 17 and stored in a supply market knowledge module.

Analysis of the supply market or particular suppliers can be carried out in different levels such as lite, professional or full, depending on the criticality value of the purchase item and/or information available. For example, FIG. 11 is an exemplary “Full Supply Analysis” page generated by the servers 22 in accordance with an embodiment of the present invention. The “Full Supply Analysis” page includes a variety of fields for collecting supply market data 1110 for the purchase item. Examples of such supply market data include, but are not limited to, market overview, market structure, and relationship. FIG. 12 is an exemplary “Full Supplier Analysis” page generated by the servers 22 in accordance with an embodiment of the present invention. The “Full Supplier Analysis” page includes a variety of fields for collecting data for preapproved suppliers for the purchase item and the supply items. Examples of supplier data include, but are not limited to, market position, market configuration, sourcing issues, market overview, market structure and relationship with the supplier.

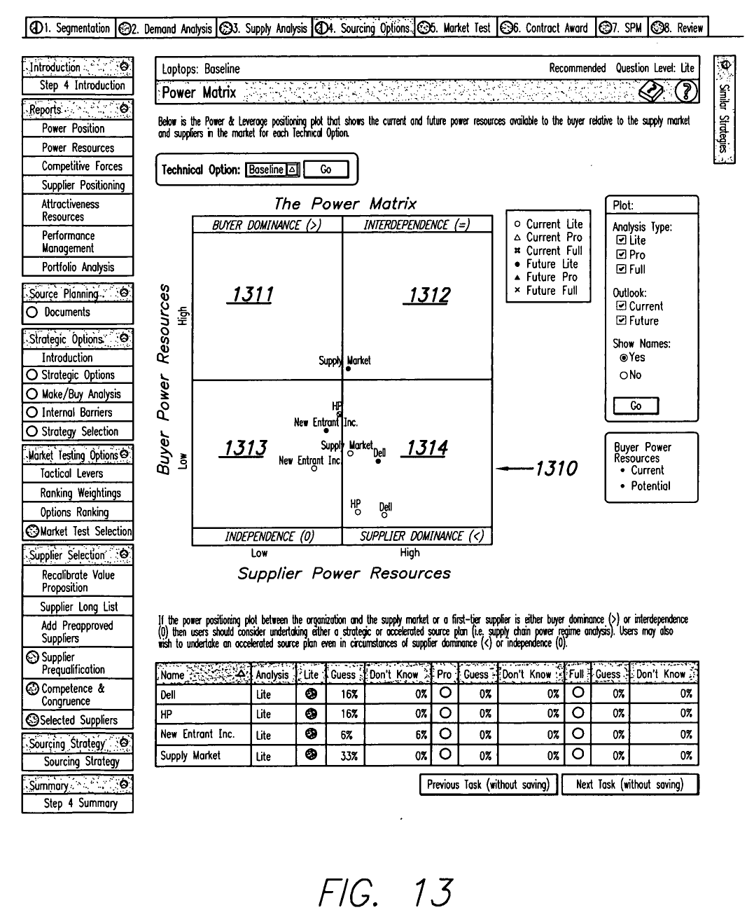

Referring now to FIGS. 13-21, in step 4, the procurement and sourcing tool 10 provides an automatic analysis and plot of current and future power positions of the buyer and the one or more supplier(s) so that the strategy team is able to view sourcing options and compare the impact of current vs. future situations. For example, FIG. 13 is an exemplary “Power Matrix” page generated by the servers 22 in accordance with an embodiment of the present invention. The “Power Matrix” page displays a power matrix 1310 with four regions: a buyer dominance region 1311, an interdependence region 1312, a supplier dominance region 1313, and an independence region 1314. The current and/or future relative position of a plurality of suppliers (e.g., Dell and Hewlett-Packard) is plotted on the Power Matrix page.

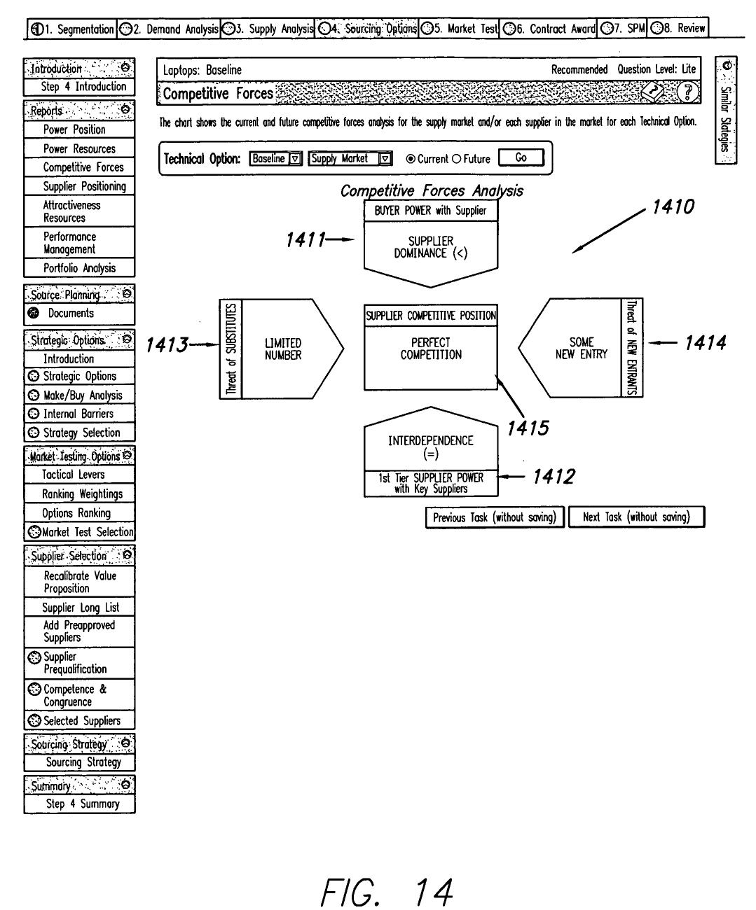

FIG. 14 is an exemplary “Competitive Forces” page generated by the servers 22 in accordance with an embodiment of the present invention. The “Competitive Forces” page displays a competitive forces analysis 1410 with five regions: a buyer power region 1411, a supplier power region 1412, a threat of substitution region 1413, a threat of new entrants region 1414, and a supplier competitive position region 1415.

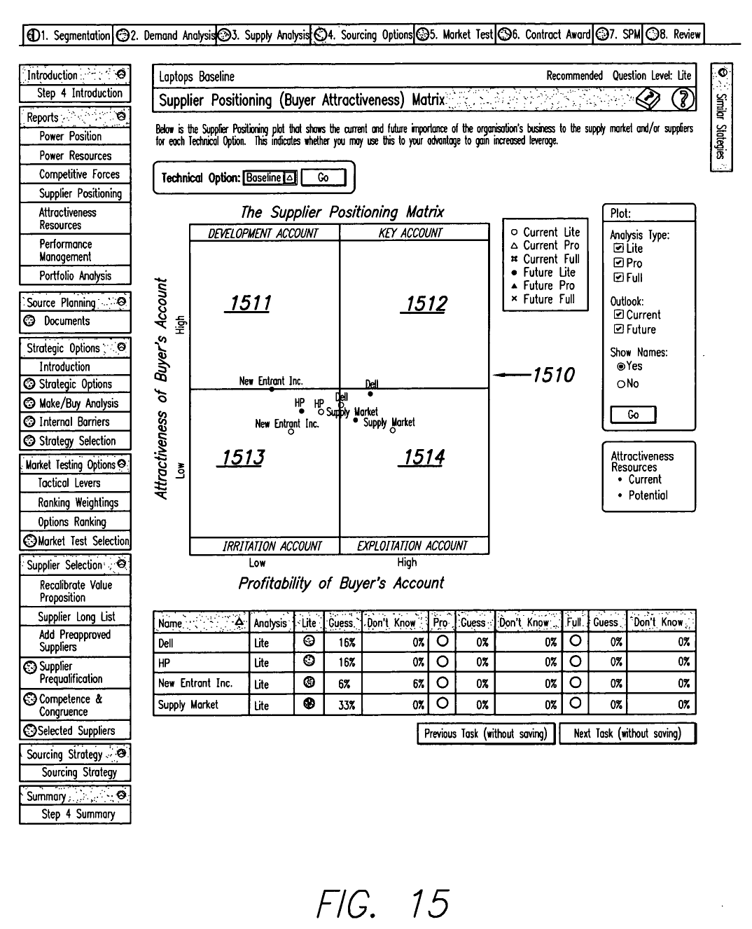

FIG. 15 is an exemplary “Supplier Positioning/Buyer Attractiveness Matrix” page displaying current and/or future relative position of a plurality of suppliers is generated by the servers 22 in accordance with an embodiment of the present invention. The “Supplier Position/Buyer Attractiveness Matrix” page displays a Supplier Positioning/Buyer Attractiveness Matrix 1510 with four regions: a development account region 1511, a key account region 1512, an irritation account region 1513, and an exploitation account region 1154.

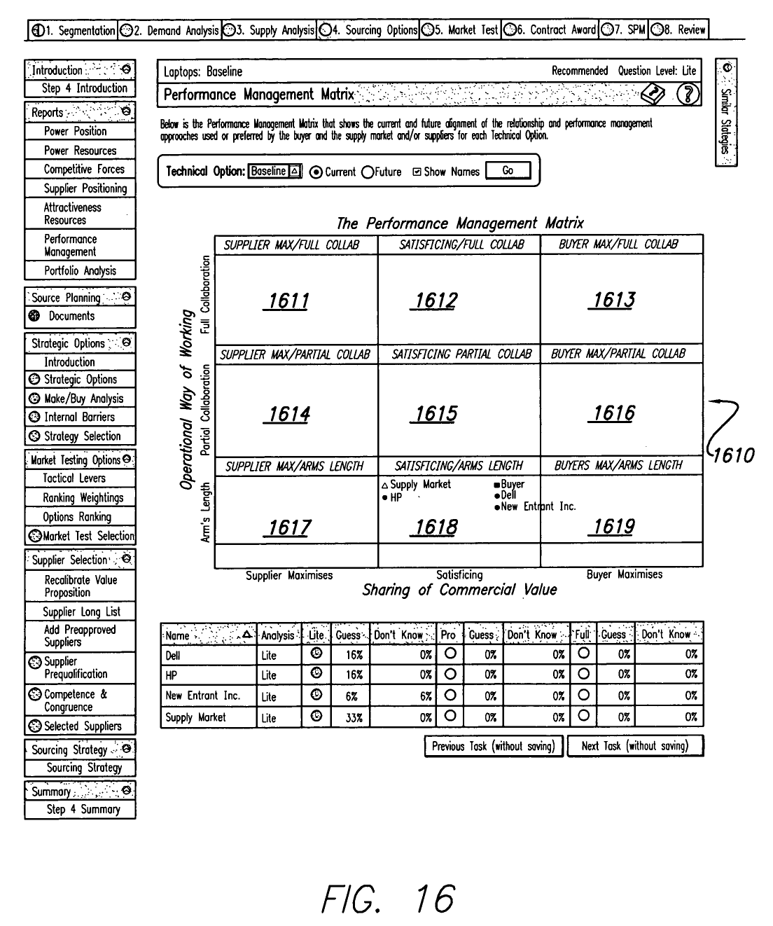

FIG. 16 is an exemplary “Performance Management Matrix” page generated by the servers 22 in accordance with an embodiment of the present invention. The “Performance Management Matrix” page displays a performance management matrix 1610 with nine regions: a full collaboration/supplier maximization region 1611, a full collaboration/satisfying region 1612, a full collaboration/buyer maximization region 1613, a partial collaboration/supplier maximization region 1614, a partial collaboration/satisfying region 1615, a partial collaboration/buyer maximization region 1616, an arms length/supplier maximization region 1617, an arms length/satisfying region 1618, and an arms length/buyer maximization region 1619.

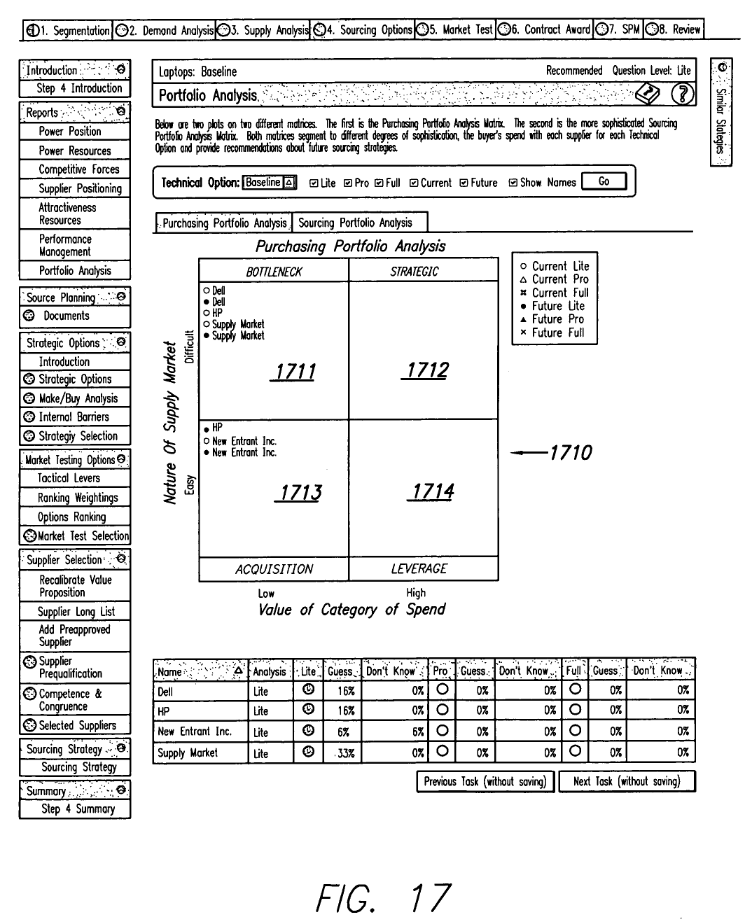

FIG. 17 is an exemplary “Purchasing Portfolio Analysis” page generated by the servers 22 in accordance with an embodiment of the present invention. The “Purchasing Portfolio Analysis” page displays a purchasing portfolio analysis 1710 with four regions: a bottleneck region 1711, a strategic region 1712, an acquisition region 1713, and a leverage region 1714.

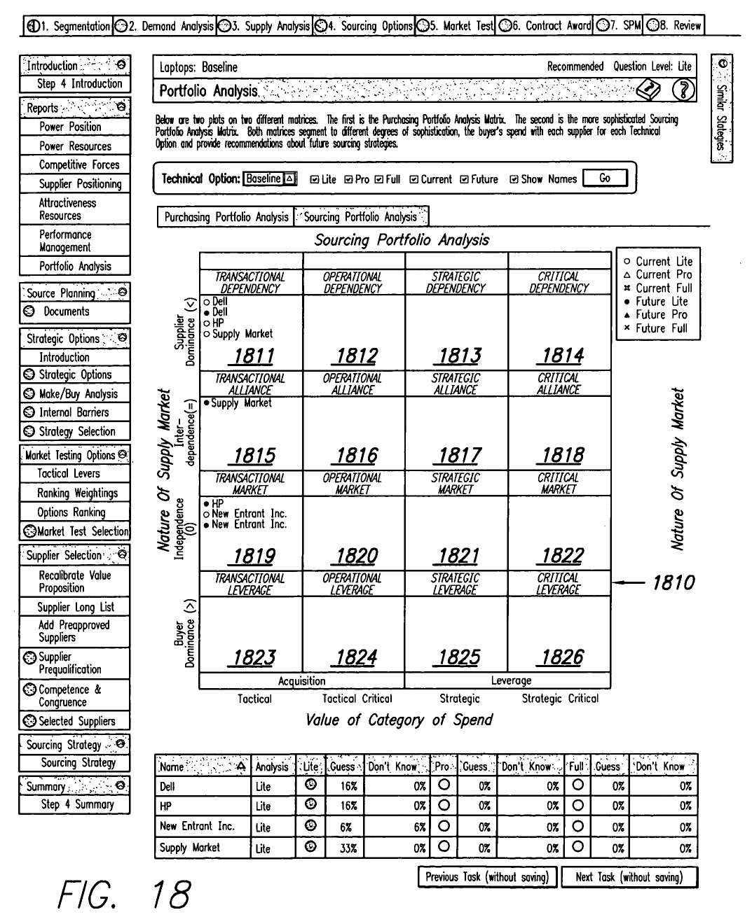

FIG. 18 is an exemplary “Sourcing Portfolio Analysis” page generated by the servers 22 in accordance with an embodiment of the present invention. The “Sourcing Portfolio Analysis” page displays a sourcing portfolio analysis 1810 with sixteen regions: tactical/dependency 1811, tactical critical/dependency 1812, strategic/dependency 1813, strategic critical/dependency 1814, tactical/alliance 1815, tactical critical/alliance 1816, strategic/alliance 1817, strategic critical/alliance 1818, tactical/market 1819, tactical critical/market 1820, strategic/market 1821, strategic critical/market 1822, tactical/leverage 1823, tactical critical/leverage 1824, strategic/leverage 1825, and strategic critical/leverage 1826. Once a particular strategy has been selected, the user 17 can direct the procurement and sourcing tool 10 to re-generate the web pages shown in FIGS. 13-18 to illustrate changes in the current and future positions of the organization with respect to particular suppliers.

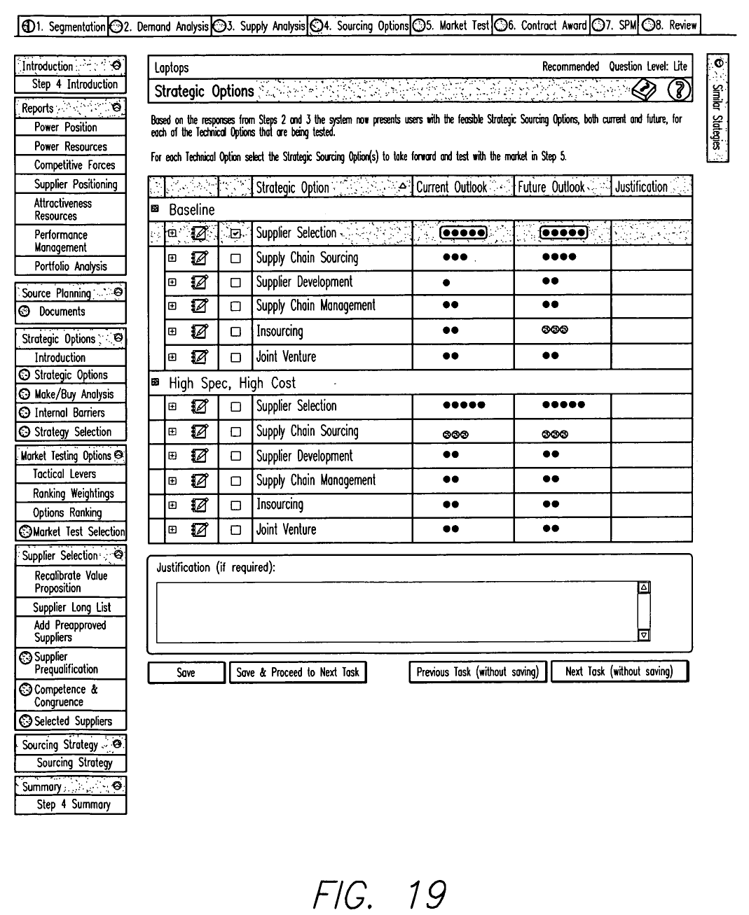

FIG. 19 is an exemplary “Strategic Options” page generated by the servers 22 in accordance with an embodiment of the present invention. The “Strategic Options” page provides the current and future status for different strategic options for the purchase item and the supply items. Examples of strategic options include, but are not limited to, supplier development, supply chain management, supply chain sourcing, insourcing, joint venture, and supplier selection. The expert system of the procurement and sourcing tool 10 works in conjunction with the strategic options page to provide (using a traffic light system—based on red (not appropriate), amber (may be appropriate) and green (appropriate)) current and future recommendations for users 17s about which strategic options may be the most appropriate to select. For example, on this page the user is shown that supplier selection is a highly appropriate strategic option in the future for the Alternative Technology, Baseline & High Spec/High Cost technical options. The other strategic options are not recommended as appropriate.

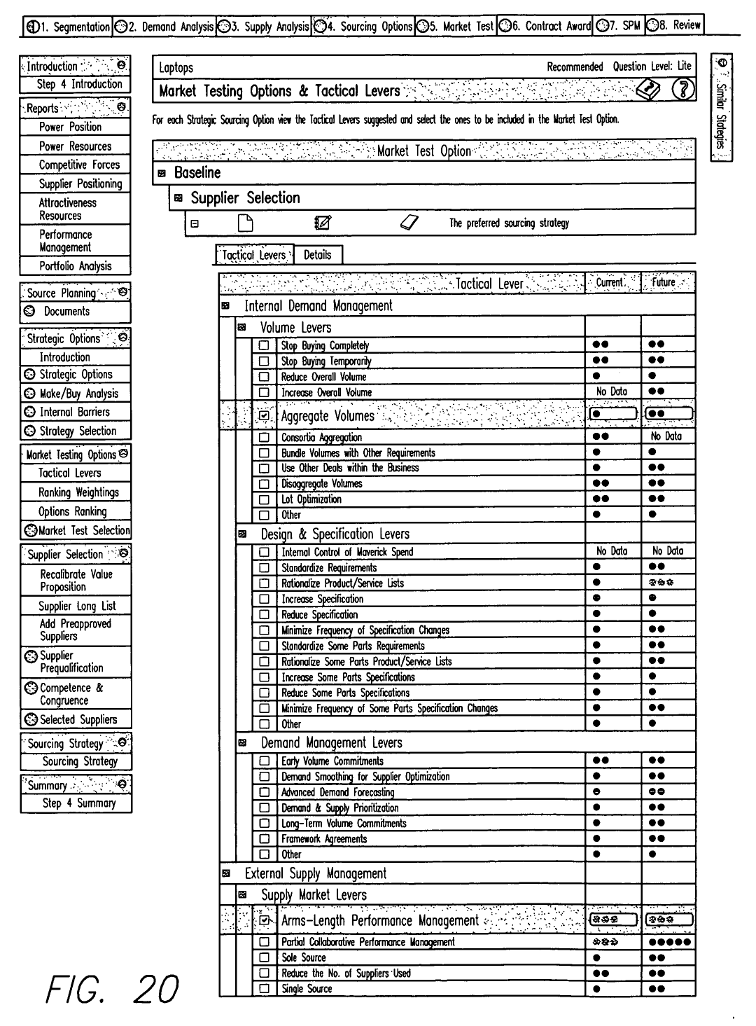

Once a strategic option is selected via FIG. 19, for example, the procurement and sourcing tool 10 provides the user 17 with a variety of predetermined tactical contractual levels/options to help the user 17 implement the selected strategy. For example, in the “Market Testing Options and Tactical Level” web page shown in FIG. 20, the selected strategic option is “Supplier Development” and a variety of tactical contractual levels/options for external process improvement, external supply management or supply market levers are provided to aid the user 17 in further developing or implementing the strategy.

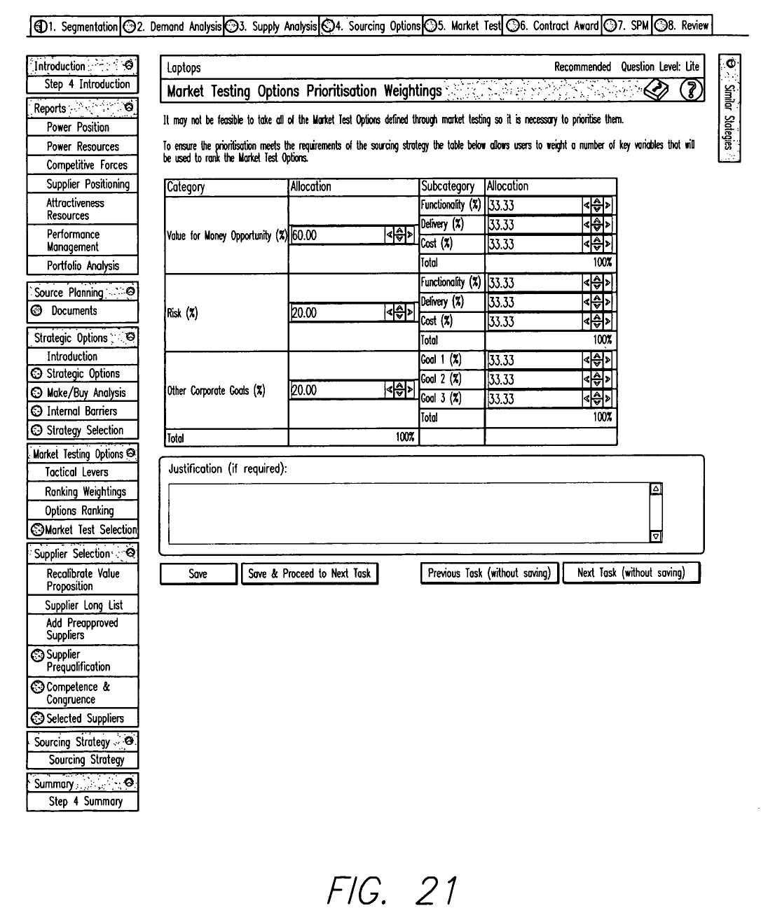

FIG. 21 is an exemplary “Market Testing Options Prioritization Weightings” page generated by the servers 22 in accordance with an embodiment of the present invention. To give recommendations on which of the selected strategic options and tactical contractual level/option shall be used to test the market with, the “Market Testing Options Prioritization Weightings” page collects inputs from the user 17 about weighting values associate with value for money opportunity (including functionality, delivery, and cost), risks (including functionality, delivery, and cost), corporate goals (including revenue generation, mission criticality, and reciprocity).

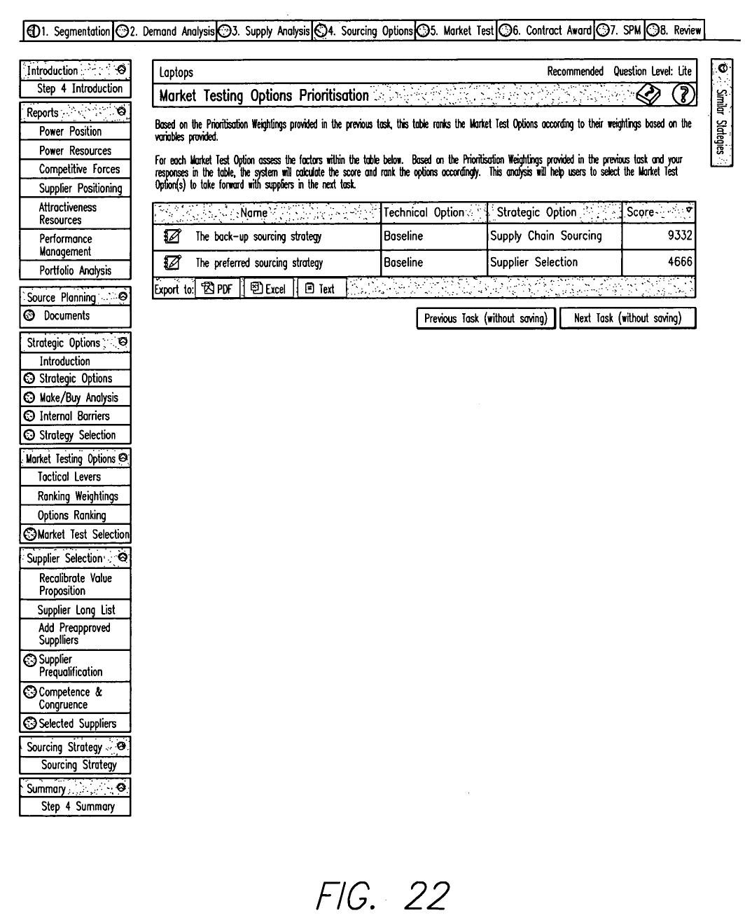

FIG. 22 is an exemplary “Prioritization” page generated by the servers 22 in accordance with an embodiment of the present invention. Based on prioritization weighting values, the servers 22 generate a prioritization score for each of the selected sourcing strategy or strategies and tactical contractual levels/options and ranks them in an order based on the prioritization scores.

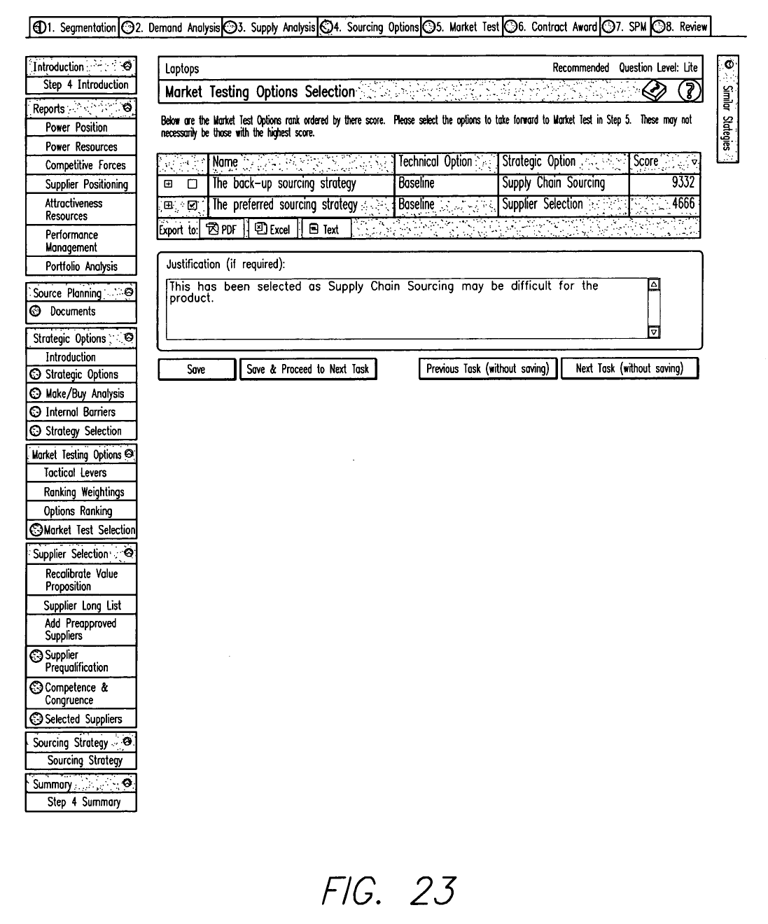

FIG. 23 is an exemplary “Market Testing Options Selection” page generated by the servers 22 in accordance with an embodiment of the present invention. Strategic option(s) and/or tactical contractual level(s)/option(s) to test market with are selected in this page. For example, in FIG. 23, the user 17 selected supplier selection as the selected strategic option to do market test. The procurement and sourcing tool 10 further provides tactical contractual levels/options associate with supplier selection to help the user 17 to implement this selected strategy.

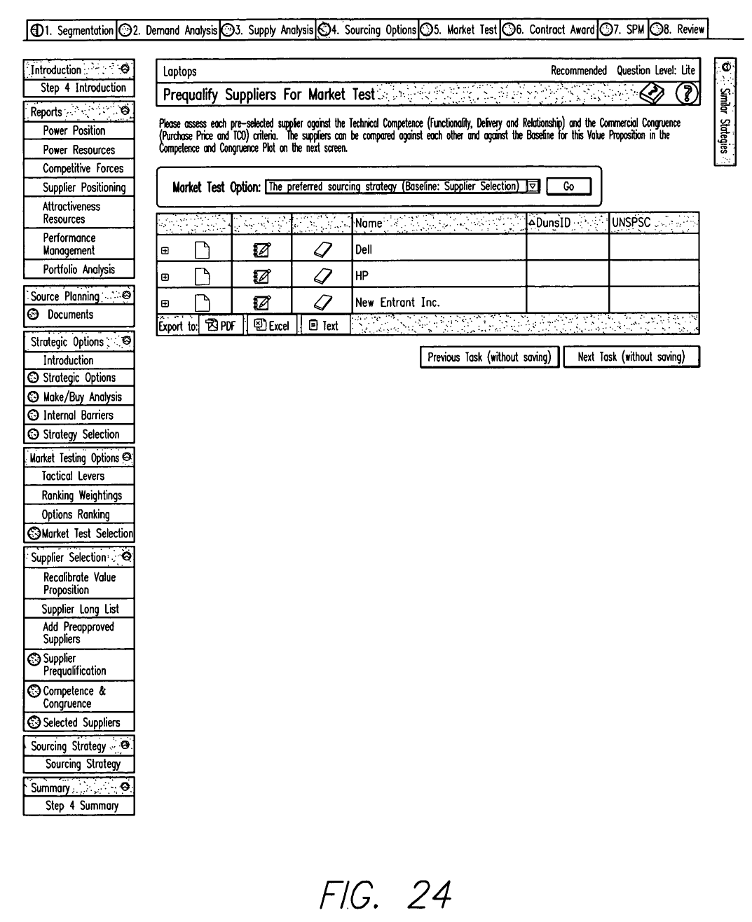

FIG. 24 is an exemplary “Pre-qualify Suppliers for Market Test” page generated by the servers 22 in accordance with an embodiment of the present invention. After selecting market testing strategic option(s)/tactical contractual level(s)/options(s), the user 17 selects suppliers from a preapproved supplier list collected in the supplier analysis in step 3. After contacting the selected suppliers through questionnaires or audits, qualified suppliers are shown as prequalified suppliers for market test in FIG. 24.

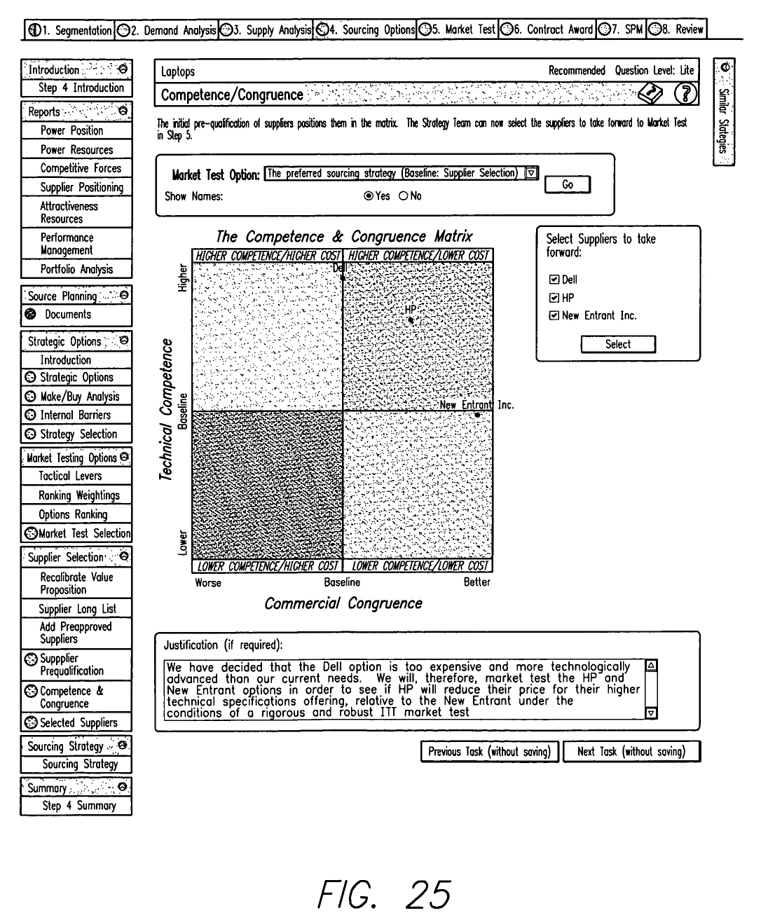

FIG. 25 is an exemplary “Competence/Congruence” page generated by the servers 22 in accordance with an embodiment of the present invention. Prequalified suppliers for market test are plotted on a competence/congruence matrix based on technical competence and commercial congruence. The user 17 can then select which of the potential suppliers to take forward for a formal market test in step 5 or amend the list of preapproved suppliers.

This description is intended for purposes of illustration only and should not be construed in a limiting sense. The scope of this invention should be determined only by the language of the claims that follow. The term “comprising” within the claims is intended to mean “including at least” such that the recited listing of elements in a claim are an open group. “A,” “an” and other singular terms are intended to include the plural forms thereof unless specifically excluded.

1. A method for enhancing the procurement processes and sourcing strategy options of an organization, comprising the steps of:
establishing communication between one or more servers and one or more user devices;
registering by the servers purchase item data from the one or more user devices, the purchase item data indicative of one or more purchase items and business criteria including delivery, functionality, relationship and total cost of ownership options corresponding to the purchase items;
registering by the servers supply item data indicative of one or more supply items and at least one supplier capable of providing each supply item, the supply item data also indicative of business criteria corresponding to the supply items;
generating technical competence and commercial congruence data indicative of the technical suitability and commercial suitability of each supply item relative to other supply items and relative to the purchase item based on the purchase item data and the supply item data;
providing by the server at least a portion of the technical competence and commercial congruence data to the one or more user devices;
registering by the servers demand market data from the one or more user devices, the demand market data indicative of: the organization's power in buyer/seller exchange; competitive forces impacting on the supplier; attractiveness to the supplier of the buyer's account; performance and relationship management options; and, approach to procurement and sourcing strategies and tactical contractual levers/options;
registering by the servers supply market data for at least one or more supply item(s) and/or supplier(s), the supply market data indicative of: power in buyer/seller exchange for the supply market and/or supplier(s); competitive forces impacting on the supplier, attractiveness to the supplier of the buyer's account; performance and relationship management options, and approach to procurement and sourcing strategies and tactical contractual levers/options;
generating one or more suggested procurement and sourcing strategies with tactical contractual levers/options based upon the power in buyer/seller exchange of the organization, the supply market(s) and/or supplier(s), each suggested sourcing strategy designed to enhance the organization's power and leverage to improve value for money relative to the supply market(s) and/or one or more supplier(s); and
providing by the server at least one of the one or more suggested procurement and sourcing strategies to the one or more user devices.

2. The method of claim 1, wherein at least one of the one or more suggested procurement and sourcing strategies is a procurement and supplier relationship and performance management strategy.

3. The method of claim 1, wherein at least a portion of the technical competence and commercial congruence data is provided to the one or more user devices in a format suitable for graphical display as one or more item positioning plots.

4. The method of claim 3, wherein at least one item positioning plot depicts the technical suitability relative to the commercial suitability of each supply item.

5. The method of claim 3, wherein the at least one item positioning plot further depicts the technical suitability and the commercial suitability of each supply item relative to a baseline item.

6. The method of claim 5, wherein the baseline item is the purchase item.

7. The method of claim 1, wherein the purchase item data includes at least one purchase item criticality selected from the group consisting of a strategic critical region, a strategic region, a tactical critical region, and tactical region; wherein each region is indicative of the relative importance of the purchase item for commercial and/or mission delivery success of the organization, and for operational delivery.

8. The method of claim 7, wherein at least one of the one or more suggested procurement and sourcing strategies is further based upon the at least one purchase item criticality.

9. The method of claim 1, wherein the demand market data is indicative of one or more pieces of information selected from the group consisting of: the current number of buyers of a purchase item and acceptable supply items, the anticipated future number of buyers of the purchase item and acceptable supply items, the organization's current proportional share of total market demand for the purchase item and acceptable supply items, the organization's anticipated future proportional share of total market demand for the purchase item and acceptable supply items, and other items indicative of the structure of the organization's anticipated demand, position in the market and sourcing levers and options.

10. The method of claim 1, wherein the supply market data is indicative of one or more pieces of information selected from the group consisting of: the current number of sellers from which a purchase item is purchased, the anticipated future number of sellers from which the purchase item will be purchased, the current number of suppliers from which the purchase item and acceptable supply items could be purchased, and anticipated future number of suppliers from which the purchase item and acceptable supply items could be purchased, and other items indicative of the structure of the supplier(s) anticipated supply market capacity and capability, position in the market and supply item levers and options.

11. The method of claim 1, wherein the step of generating one or more suggested procurement and sourcing strategies includes selecting one or more suggested procurement and sourcing strategies from a database of pre-defined suggested procurement and sourcing strategies based on the suitability of each sourcing strategy to the power in buyer and supplier exchange of the organization and the supply market and/or supplier(s).

12. The method of claim 1, wherein the one or more suggested procurement and sourcing strategies includes a plurality of suggested procurement and sourcing strategies (insourcing, joint venture, supplier development, supply chain management, supplier selection and supply chain sourcing).

13. The method of claim 12, wherein the plurality of suggested procurement and sourcing strategies are provided with appropriateness/feasibility data indicative of the relative desirability of each suggested sourcing strategy.

14. The method of claim 12, wherein the suggested procurement and sourcing strategies is provided to the one or more user devices in a format suitable for graphical display.

15. The method of claim 1, wherein the step of generating one or more suggested procurement and sourcing strategies includes individually deriving at least one of the one or more suggested procurement and sourcing strategies from the demand market data and supply market data based upon the power in buyer and supplier exchange of the organization and the supply market and/or the supplier(s).

16. The method of claim 1, further comprising the steps of:
generating by the servers market positioning data indicative of the relative market powers of the organization and the suppliers; and
providing by the servers at least a portion of the market positioning data to the one or more user devices.

17. The method of claim 16, wherein the market positioning data is provided to the one or more user devices in a format suitable for graphical display by the one or more user devices.

18. The method of claim 17, wherein the market positioning data is provided to the one or more user devices in a format suitable for graphical display as one or more market positioning plots.

19. The method of claim 18, wherein at least one market positioning plot depicts the power in buyer/seller exchange of the organization relative to the power in buyer/seller exchange of the supplier for each supply item.

20. The method of claim 18, wherein at least one market positioning plot depicts the attractiveness of the organization's account to the suppliers relative to the profitability of the organization's account to the suppliers.

21. The method of claim 18, wherein at least one market positioning plot depicts the amount of collaboration required between the organization and the suppliers relative to the commercial value distribution between the organization and the suppliers.

22. The method of claim 18, wherein at least one market positioning plot depicts the nature of the supply market relative to the criticality of the purchase item.

23. The method of claim 18, wherein at least one market positioning plot includes a plurality of delineated regions such that the position of a supply item within one of the plurality of regions is indicative of one or more characteristics of the market relationship between the organization and the seller.

24. The method of claim 23, wherein the plurality of regions are indicative of the power in buyer/seller exchange of the organization relative to the power in buyer/seller exchange of the supplier for each supply item, and wherein the plurality of regions includes at least: a buyer dominance region, an interdependence region, a supplier dominance region, and an independence region.

25. The method of claim 23, wherein the plurality of regions are indicative of the attractiveness of the organization's account to the suppliers relative to the profitability of the organization's account to the suppliers, and wherein the plurality of regions includes at least: a development account region, a key account region, an exploitation account region, and an irritation account region.

26. The method of claim 23, wherein the plurality of regions are indicative of the amount of collaboration required between the organization and the suppliers relative to the commercial value distribution between the organization and the suppliers, and wherein the plurality of regions includes at least: a full collaboration/supplier maximization region, a full collaboration/satisficing region, a full collaboration/buyer maximization region, a partial collaboration/supplier maximization region, a partial collaboration/satisficing region, a partial collaboration/buyer maximization region, an arms length/buyer maximization region, an arms length/satisficing region, and an arms length/supplier maximization region.

27. The method of claim 23, wherein the plurality of regions are indicative of the power in buyer/seller exchange of the organization in a supply market relative to the criticality of the purchase item, and wherein the plurality of regions includes at least: a bottleneck region, a strategic region, a leverage region, and an acquisition region.

28. The method of claim 23, wherein the plurality of regions are indicative of the power resources of the buyer relative to the power resources of the supplier, and wherein the plurality of regions includes four regions (a supplier dominance region, an interdependence region, an independence region, and a buyer dominance region) relative to the criticality (strategic criticality, strategic, tactical critical, tactical) of the supply item; wherein 16 potential sourcing positioning options are provided for the organization.

29. The method of claim 1, further comprising the step of:
receiving by the server option commands from the one or more user devices, the option commands indicative of an organization selection of one or more options selected from the group consisting of: procurement and sourcing strategy options, tactical contractual levers, relationship management options, performance management options, one or more supply items, and suppliers for the supply items.

30. The method of claim 1, further comprising the step of:
generating supply item performance data for one or more supply items before the award of a contract (in either a pre-evaluation, market test and/or negotiation phase) to evaluate the suitability of a supplier or suppliers based on technical competence and commercial congruence.

31. The method of claim 1, further comprising the step of:
generating supply item performance data for one or more supply items after the award of a contract to a supplier or suppliers based on pre-contractually agreed and negotiated technical competence and commercial congruence.

32. The method of claim 1, further comprising the step of:
registering by the server supplier performance data indicative of the performance of at least one of one or more suppliers and one or more supply items relative to predefined performance expectations;
receiving by the server relationship management options from the one or more user devices, the relationship management options indicative of organization selection of one or more actions to be performed on the supplier performance data, the actions selected from the group consisting of: data management actions and data reporting actions.

33. The method of claim 1, wherein the at least one suggested sourcing strategy provided to the one or more user devices includes data indicative of potential opportunities for benefits and potential risks corresponding to the at least one suggested sourcing strategy.

34. The method of claim 1, wherein all of the data generated, registered, and received by the server is stored on a computer readable medium.

35. The method of claim 1, further comprising the step of:
registering by the server organization performance data indicative of the performance of the organization's staff in performing procurement strategy activities relative to predefined performance expectations;
receiving by the server performance management options from the one or more user devices, the performance management options indicative of selection of one or more actions to be performed on the organization-performance data, the actions selected from the group consisting of: data management actions and data reporting actions.

36. The method of claim 1, further comprising the step of:
providing competence prompts regarding risks and opportunities;
registering risk and opportunity data elicited by the competence prompts; and
providing graphical representations of the opportunities and risks as well as an estimated return on investment of pursuing particular opportunities or mitigating particular risks.

37. A method for developing the competence of the staff of an organization in the management of a procurement process having a plurality of steps and the selection of procurement and sourcing strategies, the method comprising the steps of:
establishing communication between a server and one or more user devices utilized by staff of the organization;
providing, by the server, questions including competence prompts; guidance and training material to the user devices at each step of the procurement process.

38. The method of claim 37, further comprising the steps of:
generating, by the server, one or more graphical presentations of the current and future: power in buyer/seller exchange for a supply market and/or supplier(s); competitive forces impacting on the supplier, attractiveness to the supplier of the buyer's account; performance and relationship management options, and approach to procurement and sourcing strategies and tactical contractual levers/options;
generating by the server, one or more graphical presentations of technical competence and commercial congruence data indicative of the technical competence and commercial suitability of: alternative technical options; and also supplier(s), relative to the purchase item based on the purchase item criteria and the supply item criteria.

39. A method for enhancing the procurement processes and sourcing strategies of an organization, comprising the steps of:
establishing communication between a server and one or more user devices;
registering by the server purchase item data from the one or more user devices, the purchase item data indicative of a purchase item and one or more business criteria corresponding to the purchase item;
collecting information with respect to the criticality (strategic critical, strategic, strategic tactical, tactical) of the purchase item to the organization; and
providing by the server a recommended level of analysis with respect to at least one or more supply market(s) and/or supplier(s).

40. The method of claim 39, further comprising the step of:
receiving a signal indicative of a staff's selection of one of a plurality of analysis options.

41. The method of claim 40, further comprising the step of:
auditing whether the staff followed the recommended level of analysis, whether the staff completed the level of analysis undertaken, the objectivity of the data, records which questions were unanswered or incomplete, and records the justifications for any decisions or actions taken to provide an audit trail of competence

42. The method of claim 41, comprising a method for defining supplier relationship management strategies at the organization to organization rather than purchase item to supply item level; wherein the organization selects from four relationship management options comprising a gold standard and approach, a sliver relationship management standard and approach, a bronze standard and approach, and a keep in touch standard and approach.
